(19) United States
(12) Patent Application Publication
(10) Pub. No.: US 2024/0219805 A1
(43) Pub. Date: Jul. 4, 2024

(54) GEL-CONTAINING ACTIVE FLUIDIC OPTICAL ELEMENT

(71) Applicant: Meta Platforms Technologies, LLC, Menlo Park, CA (US)

(72) Inventors: Renate Eva Klementine Landig, Kirkland, WA (US); Nagi Hosni Elabbasi, Southborough, MA (US); Andrew John Ouderkirk, Kirkland, WA (US)

(21) Appl. No.: 18/149,594

(22) Filed: Jan. 3, 2023

(51) Int. Cl. G02F 1/29

(52) U.S. Cl. CPC G02F 1/29; G02F 2201/12

(57) ABSTRACT

A fluidic optical element includes a bilayer having a fluid layer and a gel layer directly overlying the fluid layer, and a primary electrode disposed over a surface of the bilayer. The geometry of an interface between the fluid layer and the gel layer and hence the optical response of the bilayer to incident light may be manipulated using the principle of dielectrophoresis.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 shows example active fluidic optical elements having different top and bottom electrode configurations according to some embodiments.

FIG. 2 illustrates the operation of an active fluidic optical element including the reconfiguration of a bilayer between paired electrodes and the formation of a periodic optical grating architecture according to some embodiments.

FIG. 3 illustrates the operation of an active fluidic optical element including the reconfiguration of a bilayer overlying a single electrode and the sinusoidal modulation of the fluid interface according to certain embodiments.

FIG. 4 shows the effect of fluid wave amplitude at normal incidence on the transmission of different diffraction orders according to some embodiments.

FIG. 5 illustrates the operation of an active fluidic optical element including the reconfiguration of a fluidic bilayer disposed between paired electrodes and the sinusoidal modulation of the fluid interface according to certain embodiments.

FIG. 6 illustrates a comparison between an optical element having a single electrode and an optical element having paired electrodes on the amplitude of the sinusoidal modulation of the fluid interface for a given applied voltage according to certain embodiments.

FIG. 7 shows continuous tuning of the amplitude of sinusoidal interface modulation with applied voltage according to various embodiments.

FIG. 8 shows the effect of shifting a top structured electrode with respect to a bottom structured electrode on the shape of a fluid interface according to some embodiments.

FIG. 9 shows the effect of biasing individually-addressable electrodes on the shape of a fluid interface according to further embodiments.

FIG. 10 illustrates the effect of a blazed grating on first order diffraction modes according to certain embodiments.

FIG. 11 depicts the formation of fluid columns using a periodic electrode configuration according to some embodiments.

FIG. 12 shows the effect of the inter-electrode spacing on the geometry of the fluid columns of FIG. 11 according to certain embodiments.

FIG. 13 shows the impact of changing the lateral offset between top and bottom electrode arrays on the tilt angle of fluid columns disposed therebetween according to some embodiments.

FIG. 14 shows the impact of changing electrode dimensions on the shape of fluid columns according to various embodiments.

FIG. 15 illustrates the modulation of a fluid interface along two in-plane directions according to some embodiments.

FIG. 16 shows the effects of gravity on a vertically-oriented active fluidic optical element according to some embodiments.

FIG. 17 shows pulse width modulation and pulse code modulation paradigms according to some embodiments.

FIG. 18 shows the impact of changing modulation wavelength on the transient turn on time for example fluidic optical elements according to certain embodiments.

FIG. 19 is a plot of contact angle versus applied voltage showing continuous tuning of the contact angle according to some embodiments.

FIG. 20 shows perspective views of a fluidic prism for (A) unbiased and (B) biased states according to various embodiments.

FIG. 21 shows continuous tuning of the interface angle of the fluidic interface with applied voltage according to various embodiments.

FIG. 22 illustrates an example liquid-gel bilayer grating architecture according to certain embodiments.

FIG. 23 shows the effect on gel modulus on grating amplitude for an example liquid-gel bilayer grating architecture according to some embodiments.

FIG. 24 shows the effect of gel modulus on response time for an example liquid-gel bilayer grating architecture according to certain embodiments.

FIG. 25 shows the effect of gel modulus on response time for an example liquid-gel bilayer grating architecture according to certain embodiments.

FIG. 26 illustrates the viscoelastic behavior of a low modulus gel associated with an applied voltage according to some embodiments.

FIG. 27 illustrates the viscoelastic behavior of a low modulus gel associated with the removal of an applied voltage according to certain embodiments.

FIG. 28 illustrates the viscoelastic behavior of a low modulus gel according to further embodiments.

FIG. 29 shows the effect of a low modulus gel in a liquid-gel bilayer grating architecture on the stability of the grating according to some embodiments.

FIG. 30 is an illustration of exemplary augmented-reality glasses that may be used in connection with embodiments of this disclosure.

FIG. 31 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

A fluidic optical element may be incorporated into wearable devices such as smart glasses and is an attractive intrant for emerging technologies including virtual reality/augmented reality devices where a comfortable, adjustable form factor is desired. Actively and continuously tunable fluidic optical elements may be incorporated into the optical aperture of an optical device such as a head-mounted display, for example, and may be used for free space beam steering, to form or constitute a transmission surface relief grating, or to provide input/output coupling for a waveguide.

Virtual reality (VR) and augmented reality (AR) eyewear devices and headsets, for instance, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. Governments may use such devices for military training, medical professionals may use such devices to simulate surgery, and engineers may use such devices as design visualization aids.

An active fluidic optical element may include a fluidic bilayer that is disposed over an electrode or between an electrode pair. The fluidic bilayer may include a liquid layer and a low modulus gel layer that define a fluid interface or boundary therebetween. In example embodiments, a fluidic optical element includes a bilayer having a liquid layer and a gel layer directly overlying the liquid layer, and a primary electrode disposed over a surface of the fluidic bilayer. According to various embodiments, an index of refraction and dielectric permittivity of a liquid or gas within the liquid layer may be unequal to an index of refraction and dielectric permittivity of a gel within the gel layer.

By applying a voltage to the one or more electrodes, the geometry of the fluid interface and hence the optical response of the bilayer to incident light may be manipulated using the principle of dielectrophoresis. By way of example, under the influence of an applied voltage, the fluid layers may be configured to form a periodic grating of alternating first and second fluid layers. The pitch of such a grating may be tunable continuously or in discrete steps, with the step size depending on the electrode configuration. The grating pitch may be spatially uniform or spatially non-uniform.

In certain configurations, gravity may have an adverse effect on the integrity of the fluidic bilayer. Whereas gravity drain of a denser fluid may lead to a non-uniform intralayer and/or interlayer thickness in comparative bilayer systems, the gel layer within the presently disclosed fluidic optical element may be sufficiently non-compliant over large length scales to obviate the effects of gravity while allowing the interface between the liquid layer and the gel layer to reversibly deform in response to the applied electric field. In example liquid-gel bilayers, surface tension may contribute to deformation of the gel layer at a certain scale, such as when the elasto-capillary length L is comparable to G/E, where G is surface stress and E is the elastic modulus of the gel. Surface stress may be related to surface tension (γ) as G=γ+dγ/dϵ′, where ε is the interfacial strain.

By way of example, a fluid layer may include a liquid selected from polyphenyl ethers, polyphenyl thioethers, 1,3-bis(phenylthio)benzene, fluorinated fluids, silicone oil, and water. Small molecules may be added to a polyphenyl ether or polyphenyl thioether, e.g., diiodomethane, inorganic compounds, such as titanium salts, organometallic compounds, or various oligomers. In further examples, a fluid layer may include a gas such as Ar, N₂, Kr, Xe, O₂, SF₆, CHF₃, CF₄, C₂F₆, C₃F₈, air, etc. as well as mixtures thereof.

Example materials for the gel layer may include various silicones and collagens, although additional dielectric and conductive media are contemplated for both the fluid layer and the gel layer. The liquid and gel layers may be mutually immiscible, whereas the respective fluids may exhibit a non-zero difference in each of their index of refraction and dielectric permittivity. In some embodiments, the dielectric permittivity of the liquid may be greater than the dielectric permittivity of the gel. In alterative embodiments, the dielectric permittivity of the gel may be greater than the dielectric permittivity of the liquid.

A gel may form from a mixture of polymers via physical linking or chemical crosslinking. A gel may include a crosslinked three-dimensional polymer network containing a large amount of liquid solvent or other fluid. A crosslinked polymer network may be formed from prepolymers through photo or heat-curing in the presence of a photo- or thermal catalyst. Example prepolymers include acrylates, acrylamides, acryloylmorpholines and their derivatives, methacrylates, methacrylamides, methacryloylmorpholines and their derivatives, polyols with isocyanates, and their derivatives, polysulfides with isocyanates and their derivatives, polythioethers and their derivatives, urethanes and their derivatives, silicones and their derivatives, and crosslinkable ionic liquids, such as 1-butyl-3-vinylimidazolium bis(trifluoromethanesulfonyl)imide. Example polymer gels include polyvinyl alcohol (PVA), polyacrylic acid (PAA), and polyacrylonitrile (PAN).

Polar functional groups, such as fluorinated groups, esters, thioketones, amides, or pyridine groups and their derivatives, may be incorporated into the polymer network of a gel to increase its dielectric constant. Example liquid solvents/fluids constituting a gel include water, aliphatic or aromatic compounds, or ionic liquids having a dielectric constant of at least approximately 5, e.g., 5, 10, 20, 30, 40, or 50, including ranges between any of the foregoing values. A fluid may include fluorinated groups, esters, thioketones, amides, or pyridine groups or their derivatives, for example. Further example liquid solvents/fluids include aliphatic or aromatic compounds having a dielectric constant of less than approximately 10, e.g., less than 5 or less than 2. Particular examples include silicone oils and mineral oils.

In some examples, the dielectric constant of a suitable solvated gel may be less than approximately 10, e.g., less than 5 or less than 2. Further example solvated gels may have a dielectric constant of at least approximately 10, e.g., 10, 20, 30, 40, or 50, including ranges between any of the foregoing values.

According to further embodiments, a gel may include a solvent-free polymer network with a high-density of high molecular weight side chains attached to a polymer backbone. Examples include bottlebrush polymer elastomers, where the dielectric constant may be less than approximately 10, e.g., less than 5 or less than 2.

In still further examples, a gel may include a solvent-free polymer network with a high-density of high molecular weight side chains attached to a polymer backbone. Examples include bottlebrush polymer elastomers having a dielectric constant of at least approximately 10, e.g., 10, 20, 30, 40, or 50, including ranges between any of the foregoing values. The polymer backbone may be aliphatic or aromatic, and ionic or charge-neutral.

The backbone of a solvent-free polymer network may be aliphatic or aromatic, and ionic or charge-neutral, and may include polynorbornene (PNB), poly(meth)acrylate (P(M)MA), polymethacrylamide, polystyrene (PS), polyacetone, polypeptides, polythiophene, polysaccharides, silicone, and the like. Side chains may include polystyrene, polyacrylate, polyglycol, polylactide, poly(3-hexylthiophene) (P3HT), crosslinkable ionic liquids, for example 1-butyl-3-vinylimidazolium bis(trifluoromethanesulfonyl)imide, or copolymers including combinations of those segments, and their derivatives. Additional polar functional groups, including fluorinated groups, esters, thioketones, amides, or pyridine groups or their derivatives, may be incorporated into the polymer network of a gel to increase the dielectric constant.

A fluidic optical element may include a gas-gel, liquid-gel, or even a gel-gel bilayer architecture. A low-modulus gel may be characterized by an elastic modulus of less than approximately 50 kPa, e.g., less than 10 kPa, or less than 1 kPa. An example gel may have an elastic modulus of between approximately 1×10² Pa and 5×10⁴ Pa, e.g., 0.1, 0.2, 0.5, 1, 2, 5, 10, 20, or 50 kPa, including ranges between any of the foregoing values. A gel may contain nanoparticles that are configured to increase the refractive index difference and/or to increase the dielectric permittivity difference between the gel layer and an adjacent fluid layer. Example nanoparticles may include BaTiO₃, ZnO, ZrO₂, TiO₂, ZnS, Nb₂O₅, SiO₂, Si, as well as combinations thereof.

According to further embodiments, in the example of a gel-gel structure, one of the gel layers may be at least partially replaced by a gas. Example gases include, but are not limited to, Ar, N₂, Kr, Xe, O₂, SF₆, CHF₃, CF₄, C₂F₆, C₃F₈, air, as well as mixtures thereof. A gas may increase resistance to dielectric breakdown while also increasing the index of refraction difference between the gel layer and the fluid layer. The two layers in a gas-containing gel-gel bilayer structure may be mutually immiscible, having a large difference in each of their index of refraction and dielectric permittivity.

In some embodiments, the mutual solubility of the two layers (e.g., liquid and gel) in a optical element bilayer may be less than approximately 1 g/100 g, e.g., less than approximately 0.1 g/100 g, or less than approximately 0.01 g/100 g. In certain embodiments, the density difference between the two layers (e.g., liquid and gel) may be less than approximately 20%, e.g., less than approximately 10%. Comparable fluid densities may inhibit or prevent gravity sag in devices where the bilayer is oriented vertically. In other embodiments, the density difference may be greater, e.g., at least approximately 20%, at least approximately 50%, at least approximately 100%, or at least approximately 200%. By way of example, the density difference between the liquid and the gel may be at least approximately 0.1 g/cm³. The liquid and gel may have a refractive index difference of at least approximately 0.1 at 550 nm, e.g., at least approximately 0.1, at least approximately 0.2, at least approximately 0.3, or at least approximately 0.4, including ranges between any of the foregoing values. The difference in dielectric permittivity between the two layers (e.g., liquid and gel) may be greater than approximately 50%, e.g., greater than 100%, 200%, 300%, 400% or 500%.

The electrode(s) may include one or more electrically conductive materials, such as a metal (e.g., silver nanowires), a semiconductor (e.g., a doped semiconductor), a conductive polymer, carbon nanotubes, graphene, oxidized graphene, fluorinated graphene, hydrogenated graphene, other graphene derivatives, carbon black, transparent conductive oxides (TCOs, e.g., indium tin oxide (ITO), indium gallium zinc oxide (IGZO), zinc oxide (ZnO), etc.), or other electrically conductive materials. In some embodiments, the electrodes may include a metal such as aluminum, gold, silver, platinum, palladium, nickel, tantalum, tin, copper, indium, gallium, zinc, alloys thereof, and the like.

Further example transparent conductive oxides include, without limitation, aluminum-doped zinc oxide, tin oxide, fluorine-doped tin oxide, indium-doped cadmium oxide, indium oxide, indium zinc oxide, indium zinc tin oxide, indium gallium tin oxide, indium gallium zinc tin oxide, strontium vanadate, strontium niobate, strontium molybdate, and calcium molybdate.

The electrodes may have any suitable geometry. Segmented electrodes, for example, may have a uniform or non-uniform shape, including varying widths where the local dimensions may be based on location within a device. Top and bottom segmented electrodes may be co-extensive or offset (i.e., shifted laterally with respect to each other). In various embodiments, floating electrodes may have smaller dimensions than connected electrodes. In some embodiments, the electrodes may have a thickness of approximately 1 nm to approximately 1000 nm, with an example thickness of approximately 10 nm to approximately 50 nm.

Plural electrodes may be combined into groups either dynamically or during a design phase. In example methods, the electrodes may be driven independently or multiplexed. Plural electrodes may be individually addressable, including with respect to a time profile, amplitude, etc.

Plural segmented electrodes may be configured as an array of electrical conductors of a pre-defined shape arranged in a pre-defined pattern such as on a line (e.g., a 1×N array), a rectangular grid (e.g., a M×N array), or a non-rectangular grid such as elements on a curve, spiral pattern, concentric circles, etc. Electrical passivation elements may be disposed between the electrodes to decrease leakage.

In an unbiased state, where an electrode or electrode pair is located approximately parallel to the bilayer, the individual layers may have an average thickness ranging from approximately 0.1 micrometer to approximately 10 micrometers, e.g., approximately 0.1 micrometer, approximately 0.2 micrometer, approximately 0.5 micrometer, approximately 1 micrometer, approximately 2 micrometers, approximately 5 micrometers, or approximately 10 micrometers, including ranges between any of the foregoing values. In an unbiased state, where an electrode or electrode pair is located approximately orthogonal to the bilayer, individual layers may have an average thickness ranging from approximately 5 micrometers to approximately 1000 micrometers, e.g., approximately 5 micrometers, approximately 10 micrometers, approximately 20 micrometers, approximately 50 micrometers, approximately 100 micrometers, approximately 200 micrometers, approximately 500 micrometers, or approximately 1000 micrometers, including ranges between any of the foregoing values.

In some embodiments, a fluidic optical element may be configured to form a prism. The prism apex angle may be tunable continuously or in discrete steps in 1 or 2 dimensions by moving the three phase contact line using the principle of dielectrowetting. In some embodiments, a fluidic optical element may be configured in an array of plural fluidic optical elements.

In an example method, the applied voltage to various electrode segments may change polarity each time the device is turned on, for example with a timescale of approximately 200 Hz to approximately 10 KHz.

An active fluidic optical element may be disposed over a transparent substrate or sandwiched between transparent substrates. A transparent substrate may be planar or non-planar and may have a thickness of less than approximately 500 micrometers, e.g., less than approximately 400 micrometers, or less than approximately 300 micrometers. A substrate may include electrical via interconnects and/or bonding pads for integration with one or more additional components, such as an integrated circuit driver. Example substrate materials include fused silica, quartz, sapphire, highly crystalline thermoplastics such as polyesters or highly crystalline polycarbonates, cyclic olefin polymers, cyclic olefin copolymers, and highly crosslinked thermoset materials such as highly crosslinked acrylates, epoxies, or urethanes.

In some embodiments, a layer of a solid dielectric material may be interposed between the fluidic bilayer and one or more of the electrodes. The solid dielectric layer may be configured to attenuate the electric field produced across the fluidic bilayer under the effects of an applied voltage and accordingly influence the shape of the actuated interface.

A solid dielectric layer may include any suitable dielectric material, including organic and inorganic compositions. Example dielectric materials include photoresist, HfO₂, Si₃N₄, SiO₂, TiO₂, Nb₂O₅, etc. In some embodiments, a dielectric layer may have a thickness of less than approximately 2 micrometers, e.g., less than 1 micrometer, or less than 0.5 micrometer. A solid dielectric layer may be characterized as a homogeneous layer or as an inhomogeneous layer, for example, including two or more dielectric materials having different dielectric permittivities. A solid dielectric layer may be optically transparent. A difference in the index of refraction between a solid dielectric layer and an adjacent electrode may be less than approximately 0.2 at 550 nm, e.g., less than approximately 0.2, less than approximately 0.15, or less than approximately 0.1.

The wettability of the liquid and gel layers and the formation of liquid and gel layers each having a substantially constant equilibrium thickness may be improved by incorporating a surface modification layer between the fluidic bilayer and one or both of the two solid surfaces that are in direct contact with each respective layer. That is, each solid surface (e.g., electrode or solid dielectric layer) may be coated with a material that favors wetting of one layer constituent over the other. In an example configuration, a solid surface that favors arrangement of a liquid layer may exhibit a wetting angle of less than 20°, e.g., less than 10°, with the liquid, and a wetting angle of greater than 50°, e.g., greater than 60° with the gel, whereas the other solid surface may favor arrangement of the gel and may exhibit a wetting angle of less than 20°, e.g., less than 10°, with the gel, and a wetting angle of greater than 50°, e.g., greater than 60° with the liquid. There may be a different degree of bonding (i.e., ionic bonding and/or hydrogen bonding) and/or polarity differential between the layers as well as between each layer and its respective solid surface. In some embodiments, an antireflective layer may be incorporated into an active optical element, such as between the fluid layer or the gel layer and an adjacent solid surface.

In some embodiments, an active fluidic optical element may include a surface modification layer. A surface modification layer may include a discrete layer (thin film) or may be characterized as a surface treatment of a solid surface. A thin film or surface treatment may be used to modify the hydrophilicity and/or oleophilicity of a solid surface, for example.

Example surface modification layers may include a benzyl-containing silane, such as benzyl triethoxy silane, phenethyl trimethoxy silane, tolyl trimethoxy silane, methoxy phenyl triethoxy silane, diphenyl dimethoxy silane, diphenyl diethoxy silane, and the like. A hydroxyl-containing silane or an ionic silane, such as a silane containing sodium salt, ammonium chloride salt, or ammonium bromide salt, may be applied to the solid surface contacting water. A fluorinated silane or a fluorinated polymer may be applied to the solid surface contacting a fluorinated fluid. Example surface treatments may include ozone or UV light exposure.

In some embodiments, a fluidic layer (e.g., a liquid layer and/or a gel layer) within a bilayer may include a surfactant. Particularly suitable surfactants include amphiphilic compounds. In such examples, hydrophilic functional groups may be selected from hydroxyl, carboxyl, carbonyl, amino, phosphate, and sulfhydryl groups. Further example hydrophilic functional groups may include anionic groups such as sulfate, sulfonate, carboxylate, and phosphate groups. Example hydrophobic functional groups may be selected from aliphatic, aromatic, and fluorinated groups. In a fluidic optical element including water and silicone gel as a bilayer pair, a surfactant may include an aromatic functional group and a hydroxyl (or amino or ionic) functional group. Through the addition of a surfactant, the interfacial surface tension of the components within the bilayer may be less than approximately 35 dynes/cm, e.g., less than approximately 30 dynes/cm, or less than approximately 25 dynes/cm.

An optical element may include a primary electrode, a secondary electrode overlapping at least a portion of the primary electrode, and a bilayer including a fluid layer and a gel layer disposed between and abutting the primary electrode and the secondary electrode.

A method may include (a) forming a fluidic bilayer between a primary electrode and a secondary electrode, the fluidic bilayer including a liquid or gas layer and a gel layer defining a boundary therebetween having a first shape and (b) applying a voltage across the bilayer in an amount effective to change the first shape of the boundary to a second shape and modify an optical response of the bilayer.

An applied voltage may be constant or variable (i.e., pulsed) and may be characterized by one or more of a duty cycle, pulse width, pulse shape, amplitude, etc. The pulse shape may be determined by the fluid dynamics and driven such that it decreases transient times or compensates for physical effects. Implementation of a pulsed voltage may decrease the overall power consumption of an optical element. An example pulse shape may be rectangular, although further pulse shapes are contemplated. In some examples, a duty cycle of a pulse may be less than 100%. A duty cycle may be temporally variable, such as with pulse-code modulation.

Various driving schemes may be used to apply a bias to the one or more electrodes. In some examples, an electrode may be driven with an AC voltage with a frequency at less than approximately 100 kHz to avoid chemical decomposition (i.e., oxidation) of the fluids and inhibit charge buildup. The AC frequency may be selected depending on the conductivity of the fluids and may be greater than approximately 30 kHz so as to be outside the audible range for human hearing. In some embodiments, an AC current having a frequency in the range of approximately 100 Hz to approximately 100 kHz may be used. In further embodiments where the liquid and gel are insulating with conductivities of less than approximately 1×10⁻¹² S/cm, e.g., less than approximately 10⁻¹³ S/cm, DC operation may be used.

The driving scheme may be synchronized with a display. For example, an image visible to the user may be created by using the fluidic grating to diffract light from an image source, where the fluidic grating is repeatedly turned on for a period of time ranging from approximately 1 ms to approximately 100 ms, and turned off for a period of time ranging from approximately 1 ms to approximately 1000 ms.

In some embodiments, the modulation of the fluidic interface/boundary may be monitored and controlled using self-capacitance sensing. This may be implemented by measuring the capacitance between a drive electrode and ground. Alternatively, the mutual capacitance may be measured between adjacent electrodes by modulating the AC waveform on one electrode and detecting the magnitude of the AC-coupled, modulated signal on the other electrode.

According to still further embodiments, the actuation state may be monitored/controlled by measuring the charge applied to an electrode, measuring the current sourced by the voltage driver, or measuring the impedance from an electrode to ground or between adjacent electrodes. For instance, the charge, current, self-capacitance, and/or impedance of one or more electrodes may be measured during actuation.

Sensing may be performed on all electrodes or a subset of electrodes. Additionally, the sensing may be time division multiplexed (i.e., sequenced) or measured in parallel (i.e., simultaneously). Sparse sensing of a limited number of electrodes may improve the measurement rate allowing for faster feedback. Sparse sensing interpolation, such as linear interpolation, may be performed between measurement points. A sensed value may be correlated to a degree of actuation (e.g., pillar or wave displacement) and used for real-time feedback to provide accurate control of the fluid-gel interfacial geometry and an associated optical response.

In some embodiments, LCD (liquid crystal display) technology may be leveraged to manufacture an active fluidic optical element. By way of example, an electrode, e.g., a transparent electrode such as an ITO electrode may be formed over the inner surfaces of a bilayer cell. To create and maintain a uniform cell gap, for instance, a layer of acrylic or resin may be shaped into a spacer on one or both sides of a cell. A spacer may be sized and shaped according to the application. A sealant process may be applied to encapsulate the fluid and gel within the cell. A sealing layer may be configured to inhibit evaporation and/or contamination of the bilayer materials. In some examples, a form factor of the optical element may be adjusted, such as by thinning of a glass layer, which may benefit wearability.

Features from any of the embodiments described herein may be used in combination with one another in accordance with the general principles described herein. These and other embodiments, features, and advantages will be more fully understood upon reading the following detailed description in conjunction with the accompanying drawings and claims.

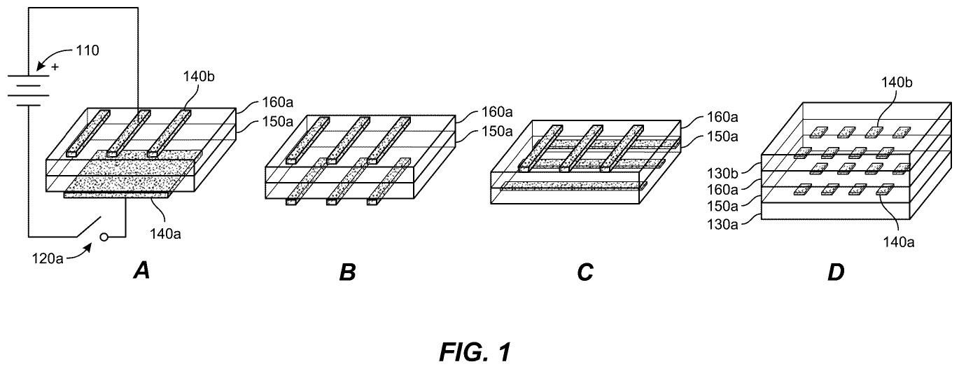

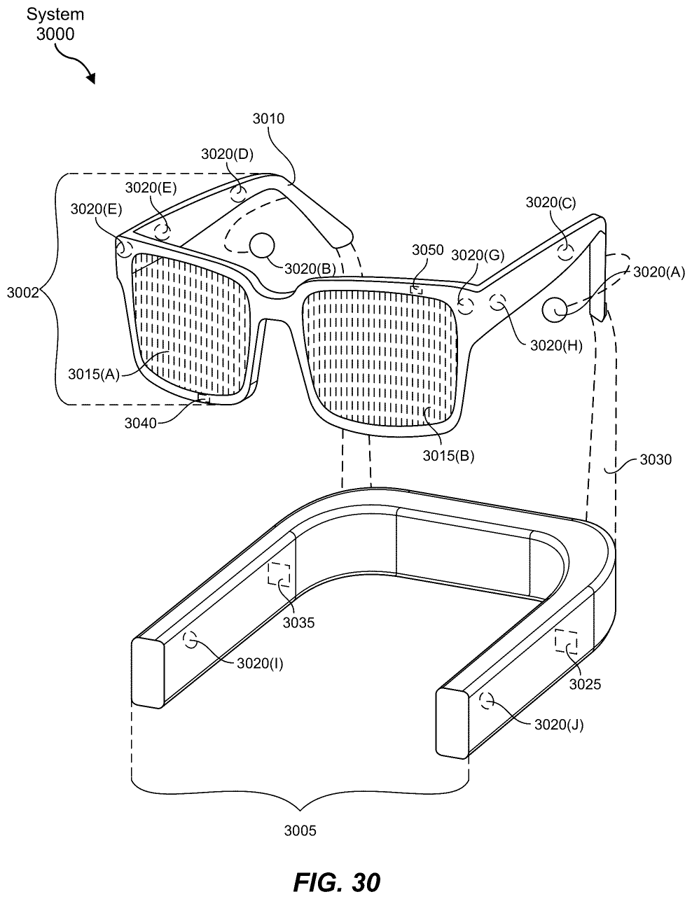

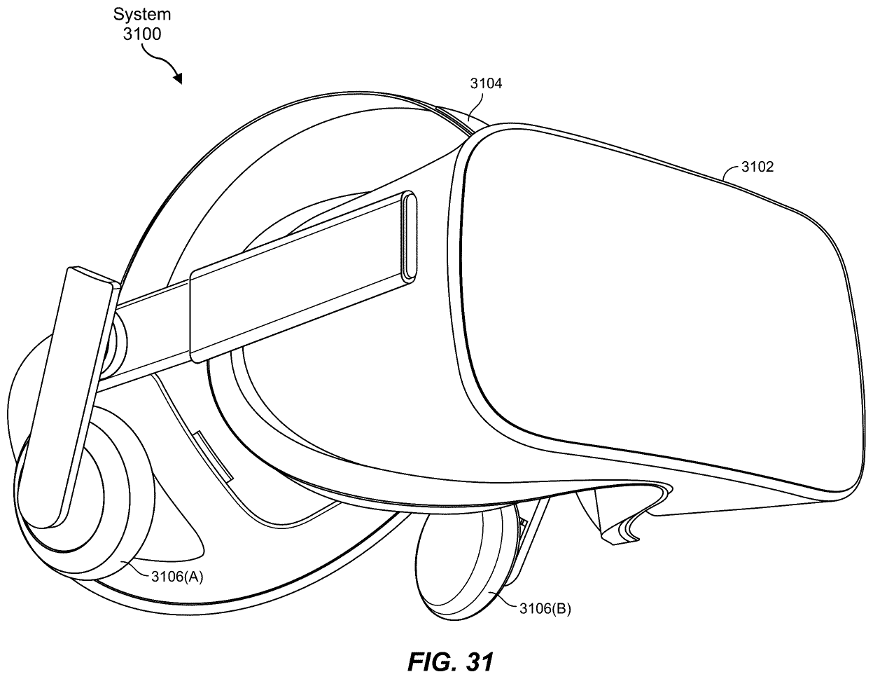

The following will provide, with reference to FIGS. 1-31, a detailed description of example active fluidic optical elements and their methods of manufacture. The discussion associated with FIGS. 1-29 relates to example fluidic optical element architectures, as well as associated characteristics and principles of operation. The discussion associated with FIGS. 30 and 31 relates to exemplary virtual reality and augmented reality devices that may include one or more active fluidic optical elements.

Referring now to FIG. 1, illustrated are example active fluidic optical elements having different configurations of paired electrodes. In FIGS. 1A-1D, the active fluidic optical elements each include a fluidic bilayer having a first layer 150a in contact with a second layer 160a, where the fluidic bilayer is sandwiched between a first electrode layer 140a and a second electrode layer 140b. For example, first layer 150a may include a gel and second layer 160a may include a liquid, or vice versa.

Referring to FIG. 1A, a fluidic optical element includes a planar bottom electrode layer 140a and an overlying patterned top electrode layer 140b each connected to voltage source 110. In one alternate configuration, top and bottom electrodes may include co-extensive linear (1D) arrays (FIG. 1B). In a further alternate configuration, top and bottom electrodes may include askew linear (1D) arrays (FIG. 1C). Referring to FIG. 1D, top and bottom electrodes may include patterned 2D arrays. In the embodiment of FIG. 1D, a bottom dielectric layer 130a may be disposed over the first layer 150a and the first electrode layer 140a, and a top dielectric layer 130b may be disposed over the second layer 160a and the second electrode layer 140b. Top and bottom electrodes may be collectively or individually addressed (or unaddressed). In some embodiments, the fluidic volumes may be switched using an active matrix backplane or a passive matrix backplane. Flexible backplanes made from organic thin film transistors and stretchable interconnects may also be used.

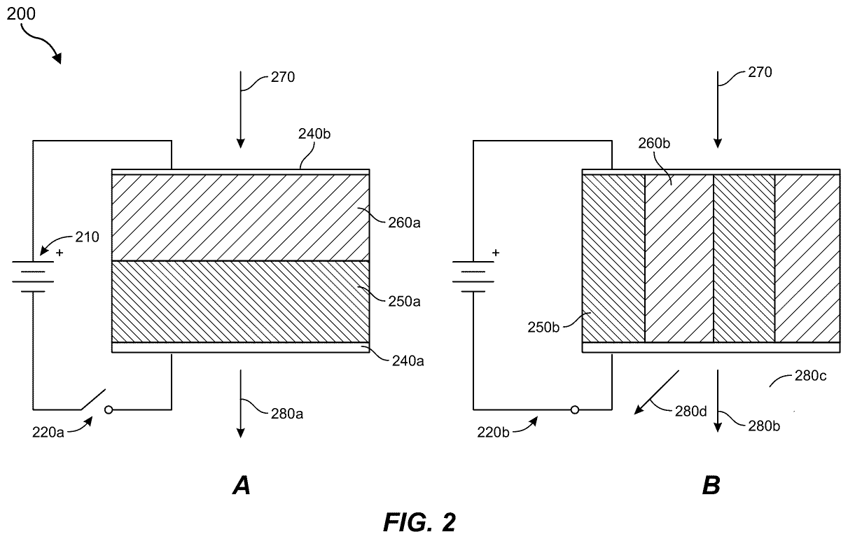

Referring to FIG. 2, shown is a schematic cross-sectional view of an active fluidic optical element according to some embodiments. The active fluidic optical element 200 includes a fluidic bilayer having a first layer 250a and a second layer 260a directly overlying the first fluid layer 250a. First layer 250a may include a gel and second layer 260a may include a liquid. Bottom and top planar electrodes 240a, 240b are respectively disposed over a surface of the first and second layers 250a, 260a, and are electrically connected to power supply 210.

Referring to FIG. 2A, in an unbiased state with the power off (220a) an example input light ray 270 may be transmitted through the optical element and emerge as an un-diffracted or substantially un-diffracted output light ray 280a. Referring to FIG. 2B, with the power on (220b), an instability at the fluid-gel interface may reconfigure first and second layers 250a, 260a as aligned columnar structures 250b, 260b that may bridge the interelectrode gap and form a binary phase grating. The grating period may correspond to an instability wavelength determined by system parameters, including the gap dimensions, the dielectric constants of the fluid and gel layers, the applied voltage, etc. Accordingly, input light ray 270 may be diffracted at the binary phase grating. Output light rays are shown schematically, including zeroth order output light ray 280b and first order output light rays 280c, 280d.

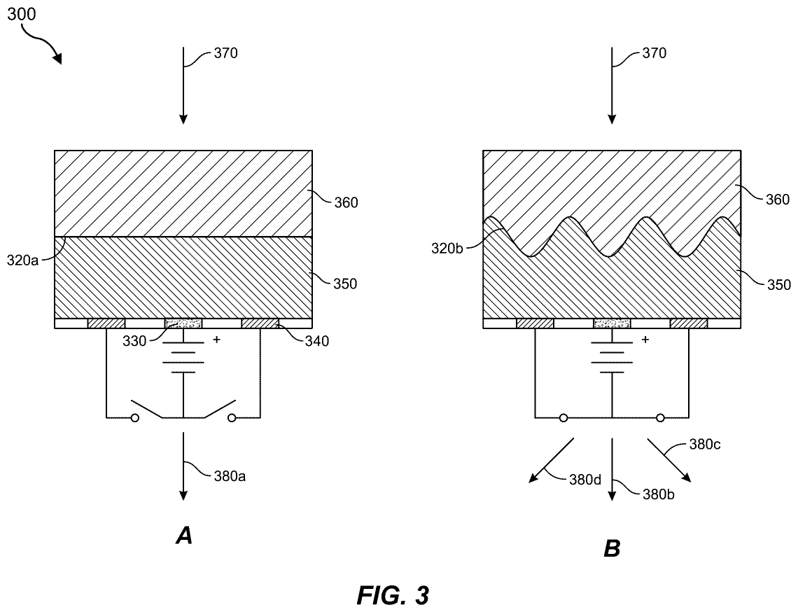

Referring to FIG. 3, shown is a schematic cross-sectional view of a further active fluidic optical element. Active fluidic optical element 300 includes a bilayer having a first layer 350 and a second layer 360 directly overlying the first layer 350. First layer 350 may include a gel and second layer 360 may include a liquid. The fluidic bilayer overlies a structured electrode having ground element 330 and powered elements 340.

In an unbiased state, as shown in FIG. 3A, an input light ray 370 may be transmitted through the optical element, including unperturbed (e.g., planar) interface 320a, and emerge as an un-diffracted or substantially un-diffracted output light ray 380a. Referring to FIG. 3B, when a bias is applied to the structured electrode, competition between surface tension and electrostatic forces may create a sinusoidal modulation in interface 320b, which may approximate a sinusoidal phase grating modulation, where the modulation amplitude to wavelength ratio may be less than approximately 3, e.g., less than approximately 1, with higher harmonics increasingly included with greater modulation amplitudes. That is, the applied voltage may induce a 3-dimensional conformal modification of the interface and generate a desired optical response.

In the illustrated embodiment, the dielectric permittivity of first layer 350 may be greater than the dielectric permittivity of second layer 360 such that the first layer may be preferentially attracted by the higher electric field gradients between the electrodes. Accordingly, input light ray 370 may be diffracted at the sinusoidal phase grating and emerge as output light rays, including zeroth order output light ray 380b and first order output light rays 380c, 380d.

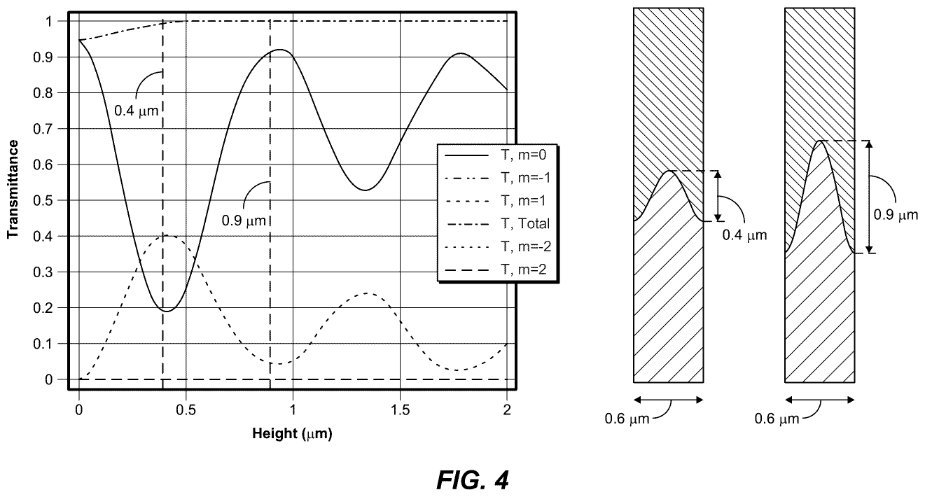

Turning to FIG. 4, in the example of sinusoidal modulation, shown schematically is the effect of the amplitude of the modified fluid-gel interface on the transmission of different diffraction orders for normal incidence.

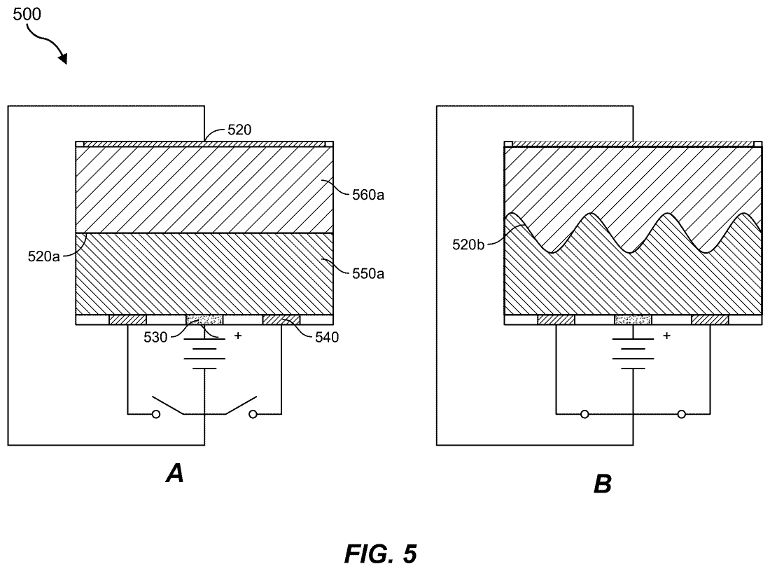

A further example active fluidic optical element is shown in FIG. 5. Referring initially to FIG. 5A, active fluidic optical element 500 may include a fluidic bilayer having a first layer 550a and a second layer 560a directly overlying the first layer 550a. First layer 550a may include a gel and second layer 560a may include a liquid, for example. The fluidic bilayer is disposed between lower and upper electrodes. Lower electrode may include a structured electrode having ground element 530 and powered elements 540, and upper electrode may include a planar electrode 520. In an unbiased state, interface 520a between the first and second layers 550a, 560a may be planar or substantially planar.

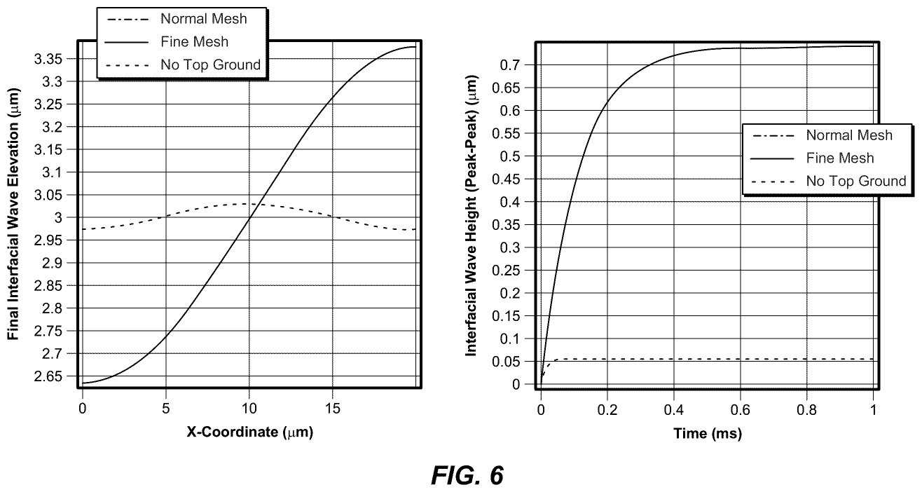

Locating the fluidic bilayer between lower and upper electrodes may result in a doubling of the wavelength of the interface modulation relative to the embodiment shown in FIG. 3, where the higher dielectric permittivity component (e.g., first layer 550a) may be drawn to where the parallel plate contribution to the electric field is strongest. Thus, referring to FIG. 5B, under an applied bias, surface tension and electrostatic forces may create a sinusoidal modulation in interface 520b. The incorporation of the top electrode may, for a given applied voltage, increase the amplitude of the sinusoidal modulation, as shown in FIG. 6.

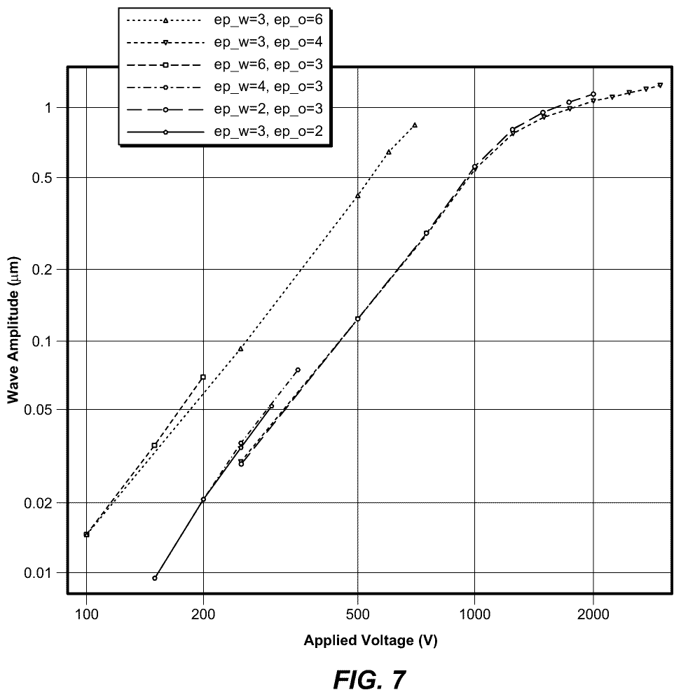

With the amplitude of the sinusoidal interface scaling as the difference in the dielectric permittivities of the first and second layers, FIG. 7 shows that the amplitude of the sinusoidal interface modulation may be continuously tuned as a function of the applied voltage.

The wave amplitude may be limited in many cases by the dielectric breakdown of one of the involved bilayer materials. That is, electrohydrodynamics is primarily driven by the electric field gradient experienced across the fluidic interface. In some embodiments, the wave amplitude may be increased by decreasing the surface tension at the interface.

A surfactant may be added to one or both of the layers. However, such an approach may induce longer transients. In particular, the turn-off transient, where the interface reverts to a planar state, is driven by the surface tension alone and may be limited by fluid viscosities. In one approach, in lieu of simply turning off the electric field, the interface may be more quickly driven back to a planar or substantially planar state by applying an electric field that actively drives the system towards the planar configuration. Thus, in an exemplary embodiment, the electric field is not turned off immediately, but switched to an out of phase configuration that accelerates fluid and gel redistribution by forcing the fluid and gel to flow from maximum to minimum locations.

According to further embodiments, the wave amplitude may be increased by incorporating a solid dielectric layer between the fluidic bilayer and at least one of the electrodes. By adding a solid dielectric layer within the high-field region immediately adjacent to an electrode, the bilayer materials may be subject to a smaller absolute electric field. A still further approach to increasing the wave amplitude may include configuring the fluidic optical element to have a non-planar interface in the unbiased state.

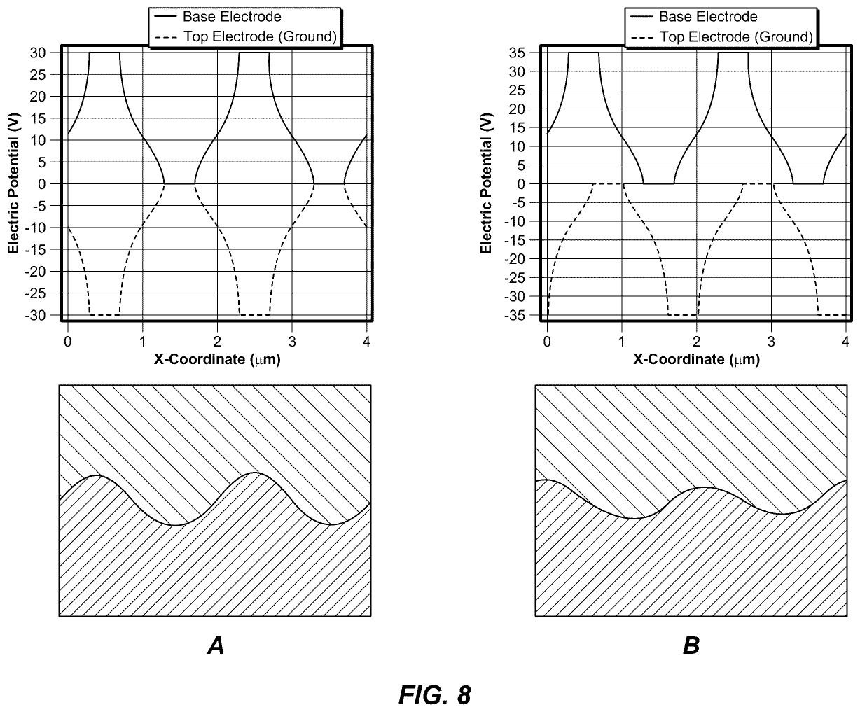

FIG. 8 shows that the modulation maxima across a fluid-gel interface may be shifted by translating (i.e., misaligning) a top structured electrode with respect to a bottom structured electrode. Additionally, this architecture may be used to introduce asymmetry to the shape of the modulation of the interface. The spatial offset may be defined during manufacture or may be adjustable. An edge transducer, for example, may be configured to translate the top structured electrode with respect to the bottom structured electrode and provide a dynamic inter-electrode array offset.

A dynamic offset may facilitate real-time tuning of the fluid-gel asymmetry and an associated adjustment of the optical properties of the fluidic optical element. In some examples, the achievable asymmetry and hence the range of the optical response for a dynamic system may be greater than the asymmetry and response attainable for a fixed configuration. This may be achieved by decreasing the driving voltage, e.g., by at least approximately 5%, as the top and bottom electrodes are displaced with respect to each other.

By way of example, and with reference initially to FIG. 8A, bottom and top structured electrodes are co-extensive, whereas in FIG. 8B, the top electrode is shifted by approximately one third of the inter-electrode spacing, resulting in a related shift of the interface modulation maxima and an attendant introduction of an asymmetry away from sinusoidal. In this embodiment, the top structured electrodes are at one potential, and the bottom structured electrodes are at a different potential.

In a further embodiment, the structured electrodes may be individually addressable and driven to different electric potentials to allow the formation of a target modulation wavelength and modulation asymmetry. In yet another embodiment, the electric potentials may be temporally offset to facilitate the formation of the target modulation wavelength and modulation asymmetry.

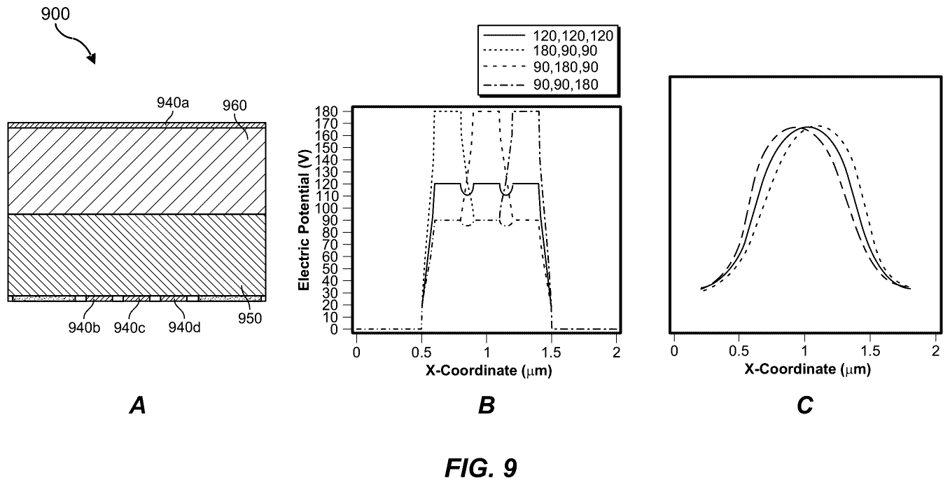

Referring to FIG. 9, shown schematically is a further embodiment related to shifting modulation maxima. In the embodiment of FIG. 9, an active fluidic optical element 900 includes a bilayer having a first layer 950 and a second layer 960 collectively sandwiched by a bottom electrode and a top electrode. First layer 950 may include a gel and second layer 960 may include a liquid, for example. The top electrode 940a may include a planar electrode, and the bottom electrode may include individually addressable electrodes 940b, 940c, and 940d.

The potential applied to electrodes 940b, 940c, and 940d is shown in FIG. 9B for different examples. The application of different voltages may be used to shift the maxima of the interfacial modulation, as depicted in FIG. 9C.

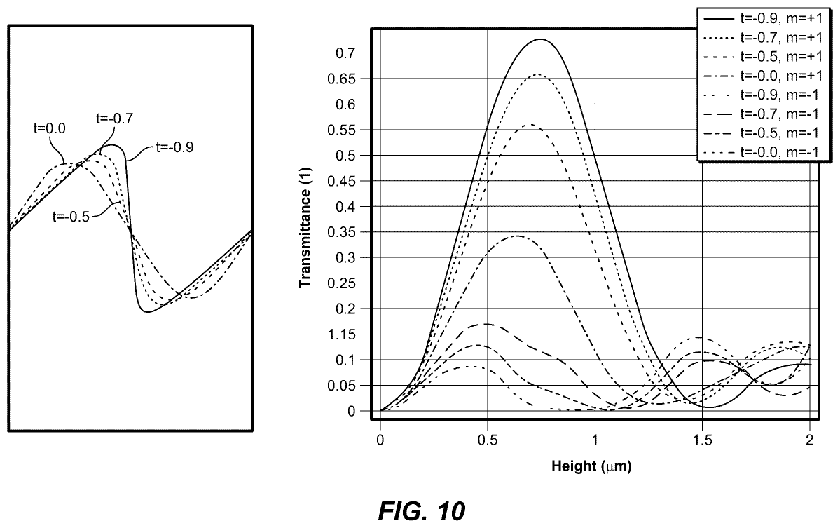

According to further embodiments, modulation asymmetry may be introduced to increase diffraction efficiency into a certain diffraction order. FIG. 10 shows an example illustrating how a blazed grating may change the two first order diffraction modes, favoring diffraction into the +1st order over the −1st order.

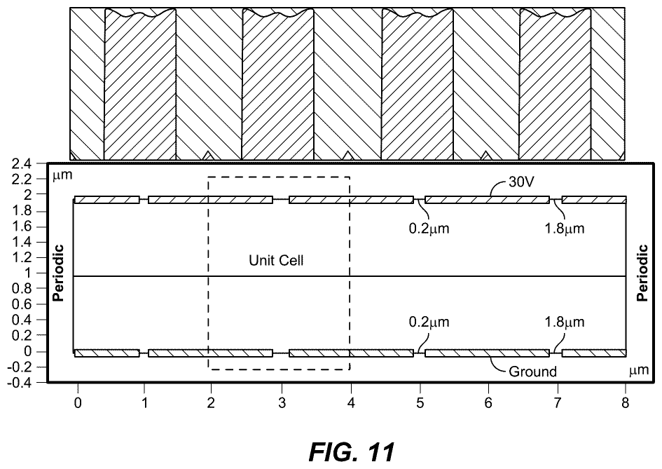

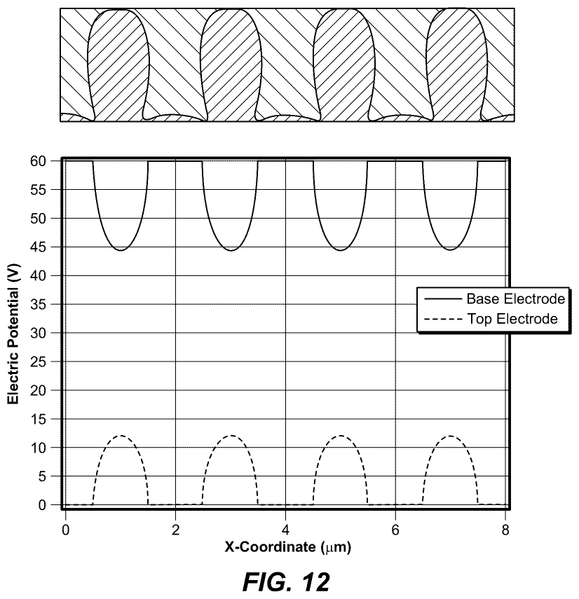

Referring to FIG. 11, illustrated is an example embodiment where the layers form columns instead of finite stable wave amplitudes. The periodic electrode configuration for this case is also shown. In addition, by changing the electrode width while keeping the spacing between the center of neighboring electrodes fixed, the shape of the individual fluid and gel columns can also be controlled, as shown in FIG. 12.

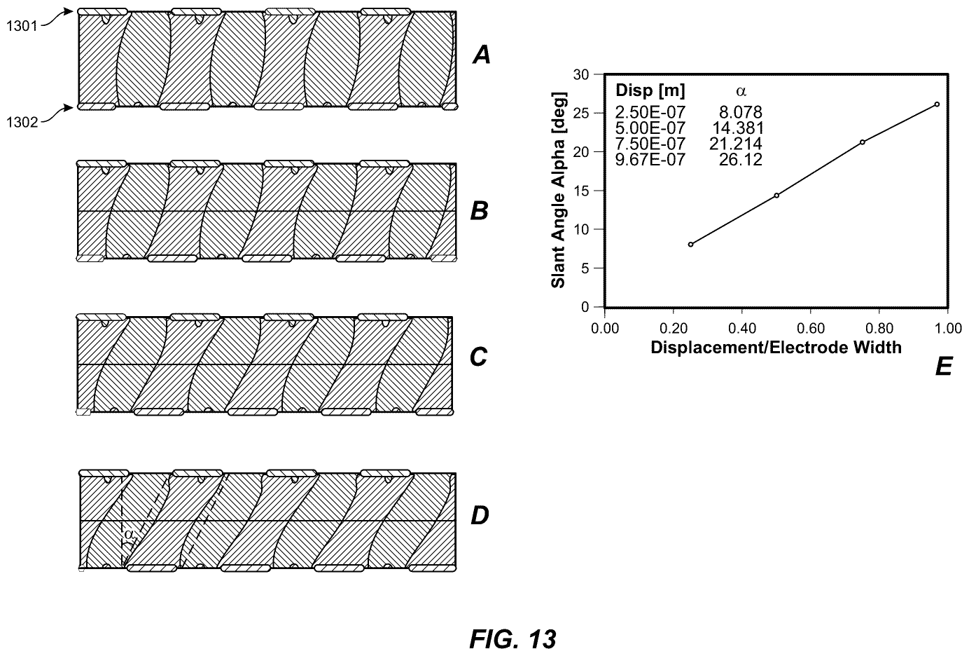

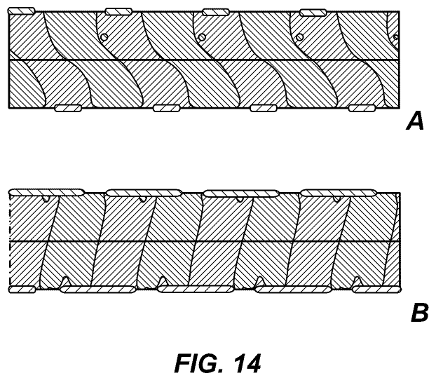

Referring to FIG. 13, asymmetric fluid/gel columns may be formed by offsetting the top electrode array 1301 with respect to the bottom electrode array 1302. Moreover, with reference to FIGS. 13A-13D, an angle of inclination (a) of the columns may be increased by increasing the lateral offset between the top and bottom electrode arrays 1301, 1302. A plot of the tilt angle (a) with respect to a normalized inter-electrode displacement is shown in FIG. 13E. In addition, by changing the electrode width while keeping the spacing fixed between the center of neighboring electrodes, the shape of the individual columns can be controlled, as shown in FIGS. 14A and 14B.

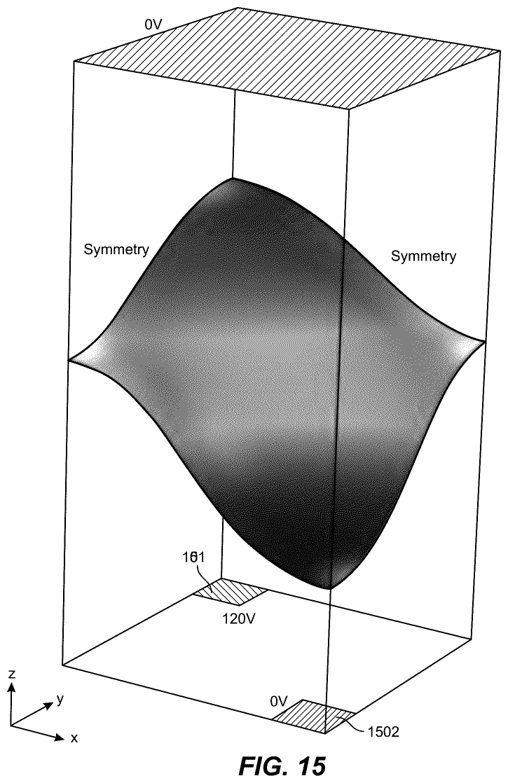

FIG. 15 illustrates an embodiment where the electrode placement results in a wave profile that is modulated along two in-plane directions. Planes of symmetry on all four side faces are shown for reference. A voltage may be applied to electrode 1501, whereas electrode 1502 may be kept at zero potential. Other placements of the electrodes can also achieve the same wave profile. In the illustrated embodiment, the wavelength along both in-plane directions (x and y) is the same, but it may be varied.

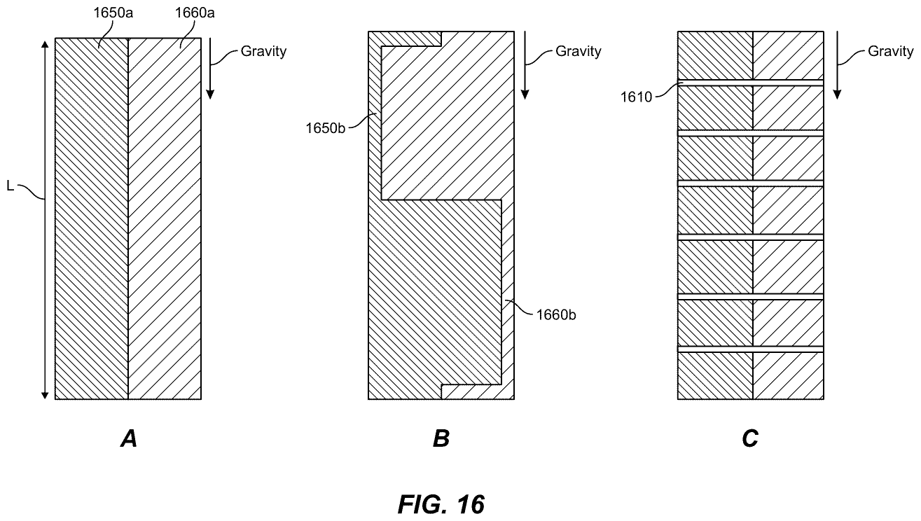

The effect of gravity on a vertically-oriented fluidic bilayer is shown in FIG. 16 for different embodiments. As will be appreciated, gravity drain of the heavier component may lead to a non-uniform intralayer and/or interlayer thickness. A desired state is shown in FIG. 16A, where first layer 1650a and second layer 1660a are arranged parallel to the axis of gravity and each have a substantially constant thickness.

Referring to FIG. 16B, a density mismatch between the two layers may give rise to a drainage phenomenon where the heavier bilayer component migrates downward causing a sagging interface. In a deformed state, only a thin coating 1650b of the first material and a thin coating 1660b of the second material remain in select regions of the redistributed bilayer. Without wishing to be bound by theory, if the vertical size of the fluid/gel volume is small, both surface tension and interfacial tension may dominate inertial forces. On the other hand, for larger systems, e.g., L>5 mm, undesirable drainage may occur for fluids such as water and oil.

Referring to FIG. 16C, according to some embodiments, shown is the incorporation of one or more partitions 1610 into the bilayer volume. The partitions may be planar or non-planar and may be configured to inhibit material redistribution under the effect of gravity away from a desired state (FIG. 16A) and toward an undesired state (FIG. 16B). Each partition may be optically transparent and of any suitable geometry. An inter-partition spacing may be less than approximately 10 mm, e.g., less than 5 mm, for example.

In certain embodiments, gravity may be compensated by a vertical voltage gradient. Such a voltage may increase (decrease) along the direction of gravity if a lighter bilayer material has a higher (lower) relative permittivity compared to a heavier material. This voltage gradient may be superposed on local voltage variations. A reset protocol could also be envisioned where only the voltage gradient would be applied to equalize layer thickness, e.g., upon system startup.

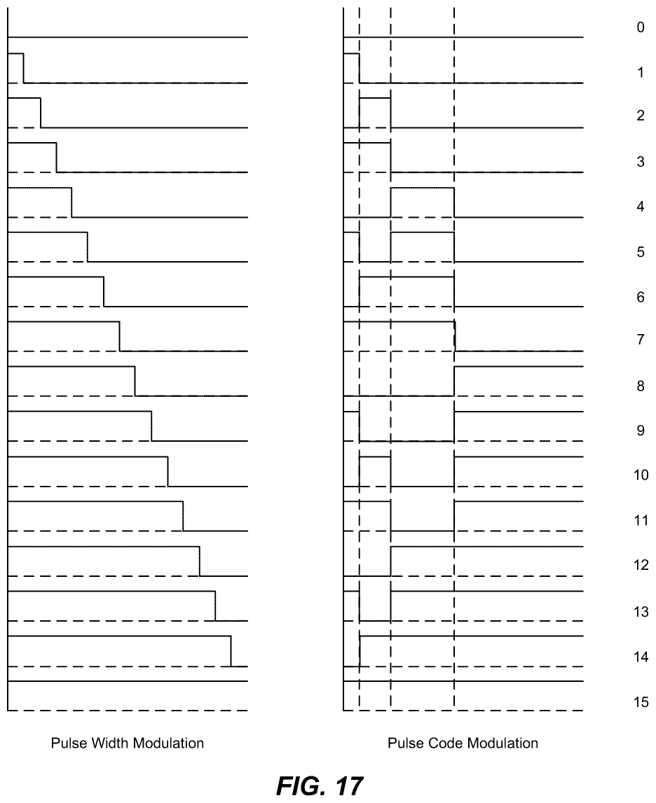

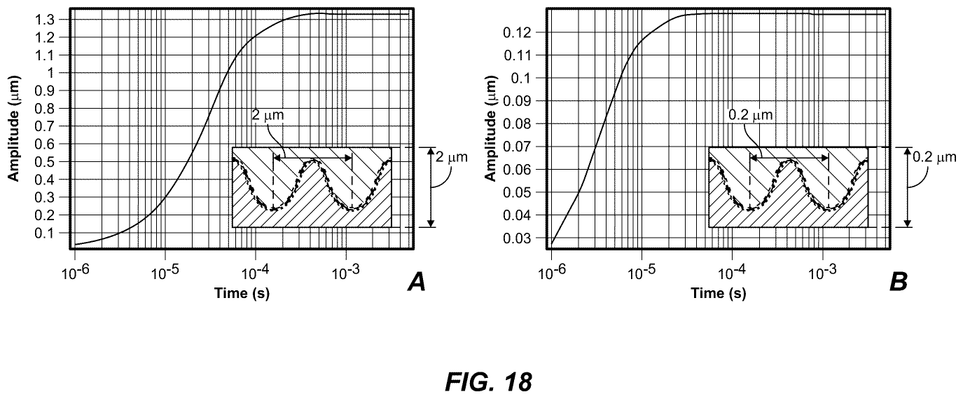

Schematic illustrations of pulse width modulation and pulse code modulation paradigms suitable for controlling a fluidic optical element are shown in FIG. 17. Referring to FIG. 18, depicted are plots that show the effect of changing the modulation wavelength on the transient turn on time for example fluidic optical elements. In some embodiments, the transient turn on time scales with the pitch of the modulation.

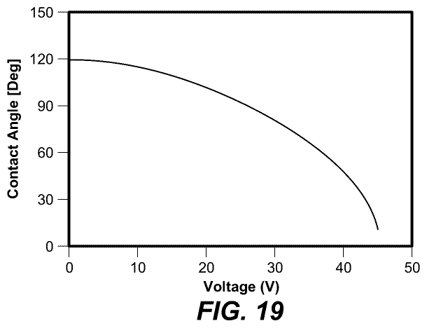

The effect of dielectrowetting and the continuous tuning of the contact angle of a dielectric fluid subject to an inhomogeneous electric field is shown in FIG. 19. The wetting angle of a droplet directly overlying a surface of an electrode array may be decreased by applying a voltage to the electrode array. In some examples, the droplet may be encapsulated by a second immiscible fluid. Changes in the wetting angle may change the three phase contact line.

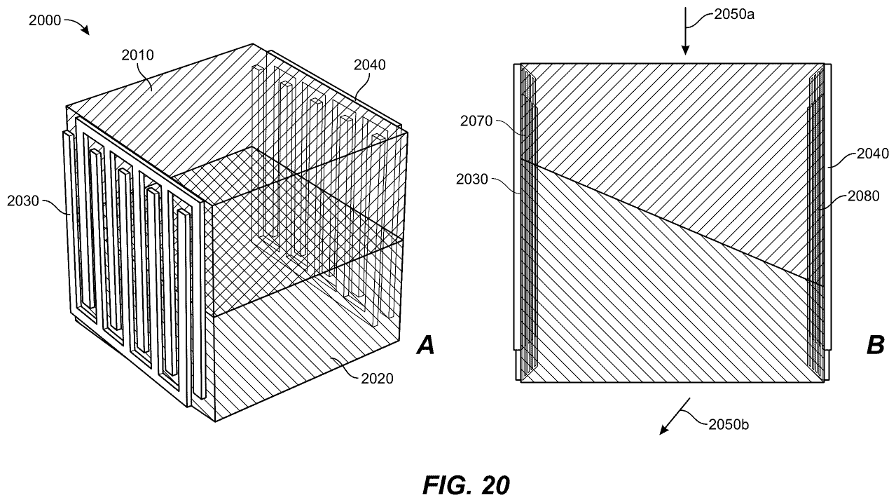

Turning to FIG. 20, shown is a perspective view of a further active fluidic optical element. Referring initially to the unbiased state of FIG. 20A, active fluidic optical element 2000 includes a bilayer having a first layer 2010 and a second layer 2020 directly underlying the first layer 2010. First layer 2010 may include a liquid and second layer 2020 may include a gel, for example. Opposing interdigitated electrodes 2030 and 2040 are located on two opposing sides of the device. The bilayer surfaces facing the interdigitated electrodes may be coated by a solid dielectric layer and may further have a coating that favors wetting of the bilayer material with the higher dielectric permittivity layer. A static wetting angle of the higher dielectric permittivity material may be greater than 90°, e.g., greater than 110° or greater than 130°.

In a biased state, as shown in FIG. 20B, the fluid-gel interface may be substantially planar except within regions 2070, 2080 proximate to the electrodes, thus forming a fluidic prism. In the depicted embodiment, the prism apex angle may be adjustable by applying different voltages to the electrode arrays 2030 and 2040 in such a way that the sum of the wetting angles on both sides totals 180°. An input light ray 2050a may be transmitted through the fluidic prism and emerge as a refracted output light ray 2050b.

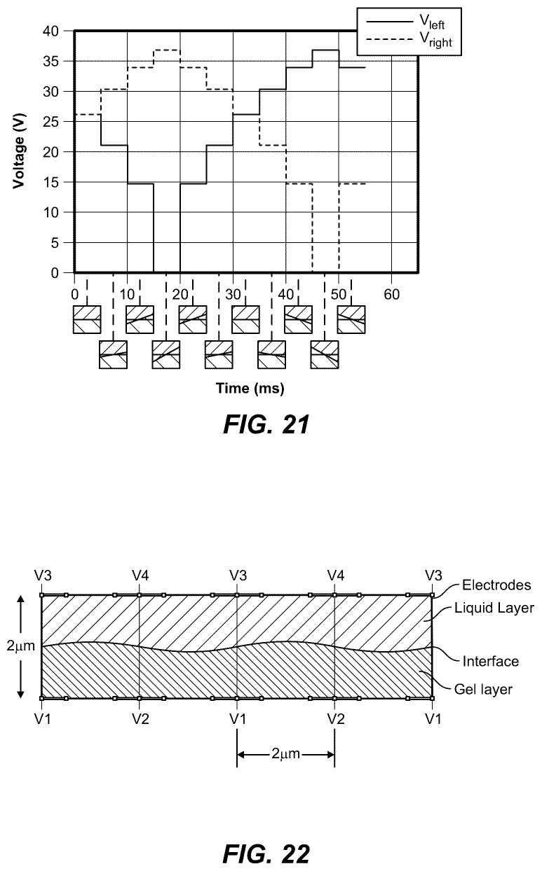

Referring to FIG. 21, according to an exemplary embodiment, applying certain combination of voltages on the left and right electrode arrays 2030 and 2040 may be used to create a continuous change in the apex angle of the fluidic prism.

Shown in FIG. 22 is a further example active optical element including a liquid-gel bilayer. Segmented and individually-addressable electrodes are disposed over opposing sides of the bilayer. In an unbiased state, the interface between the liquid layer and the gel layer may be planar. However, as shown schematically, when specific voltages (V1-V4) are applied, the interface may deform to create a periodic grating architecture.

In some examples, the applied voltage pattern can generate a grating having a wavelength that is an integral or even a non-integral multiple of the electrode spacing. Furthermore, in contrast to liquid-liquid bilayer systems, the surface tension for a liquid-gel bilayer may change more extensively without impacting the performance of the grating. This may be due to the electrostatic force between the liquid and the gel being balanced by both the surface tension force and internal forces within the gel layer.

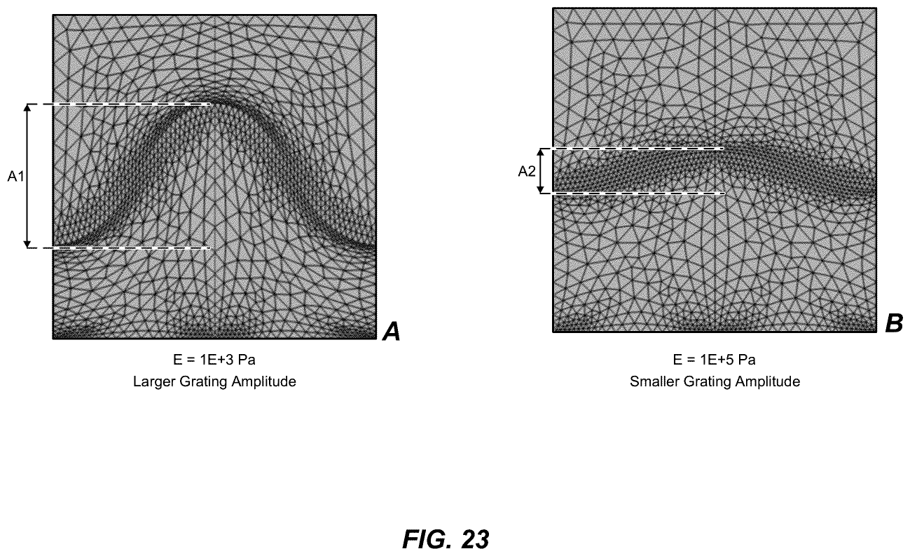

The effect of gel modulus on the amplitude (A) of a voltage-induced grating structure is shown in the modeled data of FIG. 23. As shown in FIG. 23A and FIG. 23B, for the same applied voltage, a lower modulus gel may lead to a larger grating amplitude (A1>A2). In certain examples, a larger grating amplitude may be correlated to a higher diffraction efficiency. In the illustrated embodiment, the modulus threshold to resist gravity sag is approximately 1 kPa. Although the gel modulus may affect the amplitude of a grating, the assembly and disassembly kinetics of the grating may be unaffected by modulus.

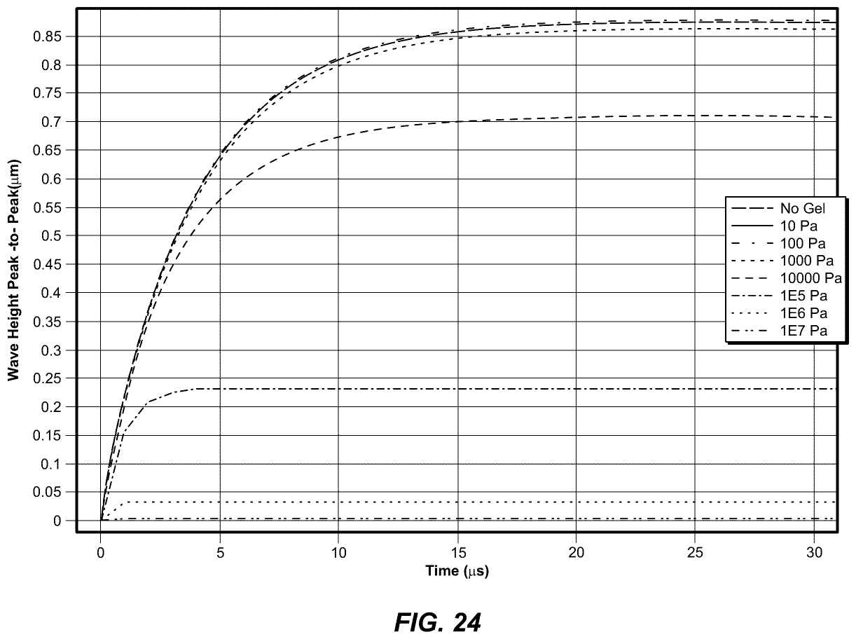

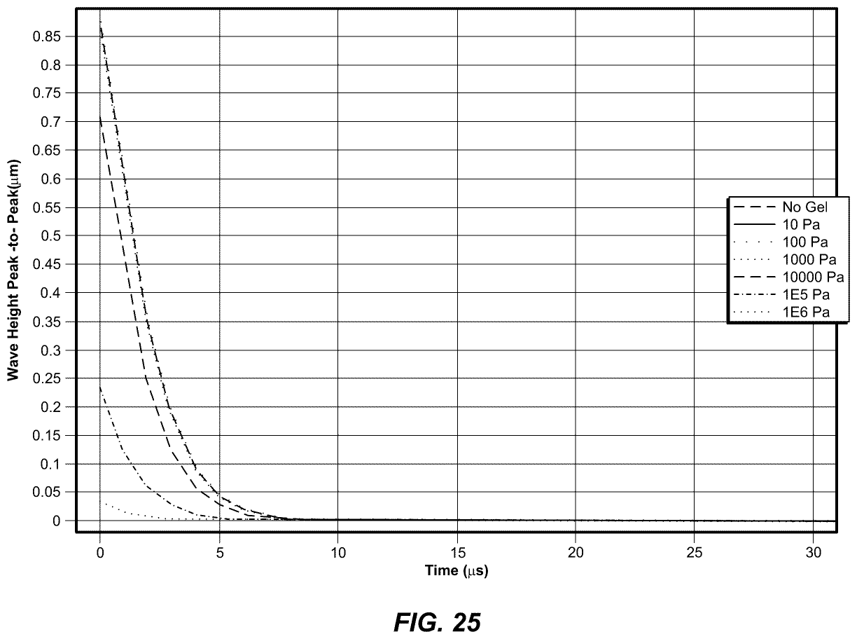

The effect of gel modulus on response time is shown in FIGS. 24 and 25. The time evolution for the assembly of liquid-gel grating architectures with an instantly applied voltage and their relaxation upon removal of the applied voltage are shown respectively in FIG. 24 and FIG. 25 for different gels having an elastic modulus spanning several orders of magnitude. Data are shown also for a comparative liquid-liquid bilayer (i.e., no gel). Over the ranges evaluated, response and relaxation times are not appreciably affected by the elastic modulus of the gel.

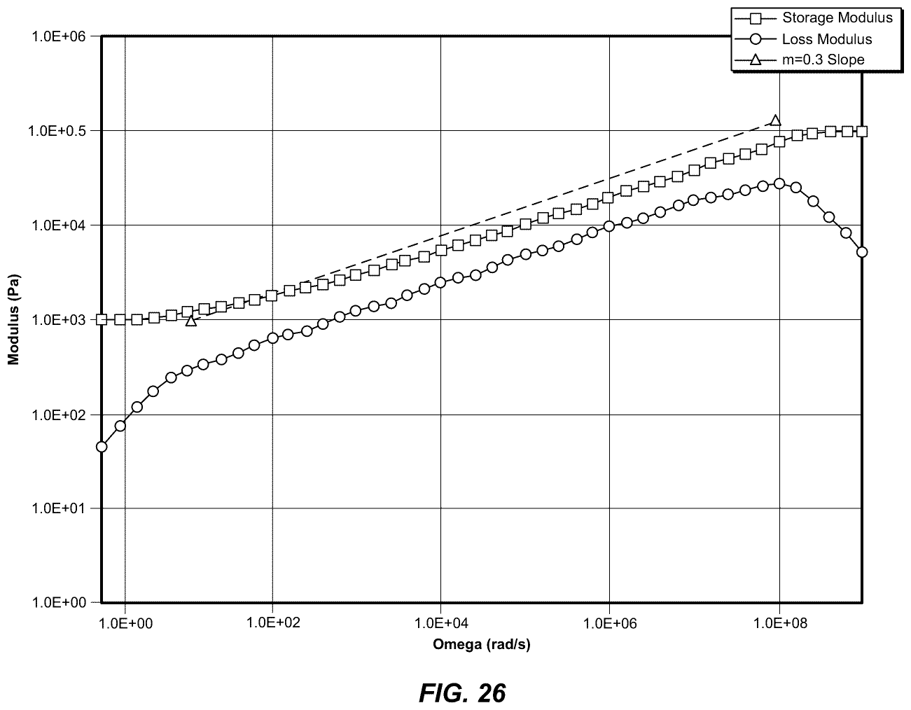

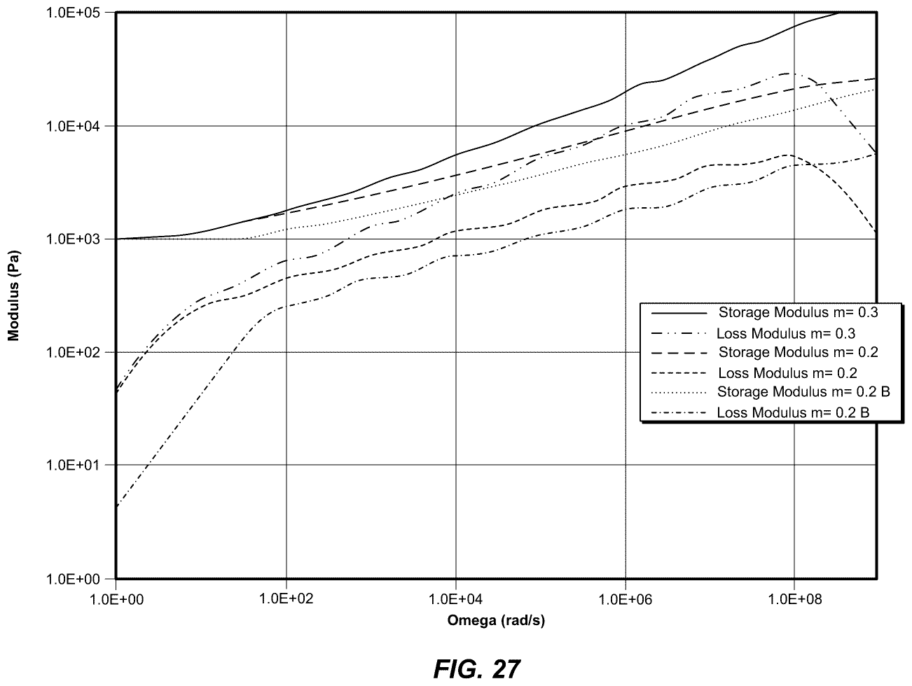

The viscoelastic behavior of example gels is shown in FIGS. 26-28. Viscoelasticity may be evaluated through the frequency dependence of a gel's storage modulus and loss modulus. A material exhibiting no viscoelastic effects will have a constant storage (elastic) modulus and zero loss modulus. Typical viscoelastic behavior of a low modulus gel is plotted in FIG. 26. Referring to FIG. 27, plotted are three different storage-loss modulus curves for three different modeled gels. While exhibiting different viscoelastic effects, each material has an approximately equivalent long term (low frequency) modulus, where the response at 1×10⁶ rad/s is exemplary. According to some embodiments, a gel may have a loss modulus of less than approximately 5×10⁴ Pa, e.g., less than 5×10⁴ Pa, less than 2×10⁴ Pa, less than 1×10⁴ Pa, less than 5×10³ Pa, less than 2×10³ Pa, or even less than 1×10³ Pa.

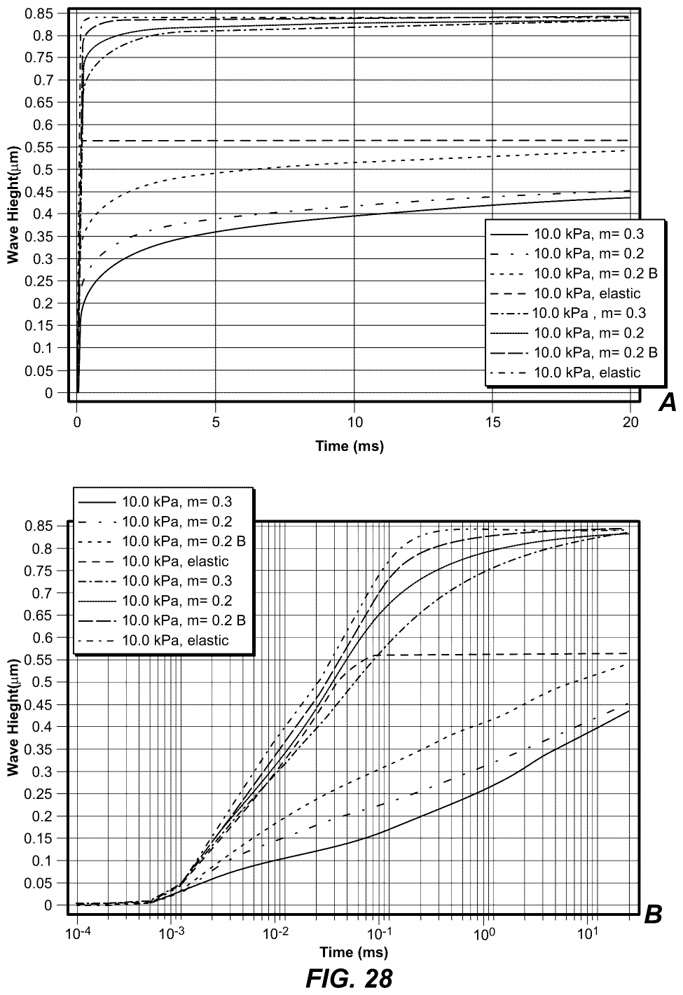

Turning to FIG. 28, shown is the actuation response for the gels of FIG. 27. Shown also for comparison is the actuation response of a perfectly elastic material. Equivalent data are plotted on a linear scale and on a log scale, respectively, in FIG. 28A and FIG. 28B. The graphs show two sets of materials one with a long term modulus of 1.0 kPa and the other with a long term modulus of 10.0 kPa.

Material “0.2 B” has a faster response time than materials “0.2” and “0.3” indicating that less stiffening with frequency may be desired for bilayer grating applications. Also, for a stiffer long term modulus, the effect of viscoelasticity decreases as evident in the curves for the 10 kPa material. For this embodiment the response time is on the order of 0.1 to 0.3 ms with no viscoelasticity, 4 ms to 20 ms for the investigated 1 kPa gels, and 20 ms to 200 ms for the investigated 10 kPa gels.

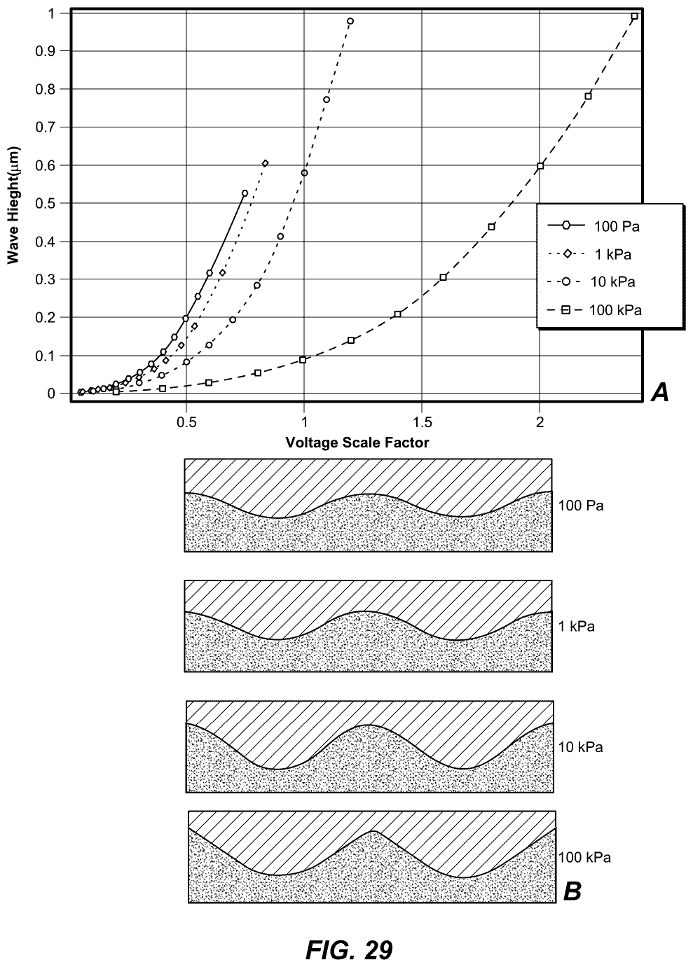

In some examples, a liquid-gel grating may be unstable beyond a certain amplitude. Referring to FIG. 29, shown are the effects of gel modulus on grating stability. A plot of wave height versus a voltage scale factor is shown in FIG. 29A for gels having a different elastic modulus, and schematic cross-sectional views of corresponding grating architectures at maximum applied voltage are shown in FIG. 29B.

As will be appreciated, gel stiffness may increase the stable wave height in a liquid-gel bilayer. Referring to the data of FIG. 29, a 100 Pa gel bilayer may be stable up to a wave height of approximately 0.5 micrometers, a 1 kPa gel bilayer may reach a wave height of approximately 0.6 micrometers before the onset of instability, and 10 and 100 kPa gel bilayers attain a maximum stable amplitude of approximately 1 micrometer. For the two stiffer (10 and 100 kPa) gels, the limiting case was due to excessive gel deformation rather than an instability onset. Example gels may be resistant to viscosity breakdown and mechanically and chemically stable notwithstanding local changes in temperature.

As disclosed herein, an active optical element includes an electroded fluidic bilayer. The bilayer may include a liquid layer and a gel layer defining an interface therebetween. Under the influence of a voltage applied to one or more electrodes, the resulting electric field may induce a conformal change in the shape of the interface and an attendant modification in the optical response of the fluidic bilayer to incident light. The incorporation of a low modulus gel into the bilayer may advantageously inhibit gravity drainage and prevent the generation of unwanted optical artifacts during operation. Such an active optical element may be continuously tunable and operable, e.g., as an optical grating, using the principle of dielectrophoresis acting on the interface.

An optical element may include a single electrode or paired electrodes sandwiching the fluidic bilayer. The electrode(s) may be optically transparent and may have a blanket or patterned geometry. In some examples, paired electrodes may wholly or partially overlap, or may be laterally offset along opposite sides of the bilayer.

The liquid and gel layers may include any suitable dielectric media and may be characterized by comparable densities, yet disparate indices of refraction and dielectric permittivity. Example liquid fluids include polyphenylethers, benzenes, silicone oils, and water. Example gels may include various silicones and collagens.

In some embodiments, a solid dielectric layer may be interposed between the fluidic bilayer and one or more of the electrodes. The solid dielectric layer may be configured to attenuate the electric field produced across the bilayer under the effects of an applied voltage and accordingly effect the shape of the interface. The applied voltage may be constant or variable (i.e., pulsed) and may be characterized by one or more of a duty cycle, pulse width, pulse shape, amplitude, etc.

In some applications, the gel modulus within an active fluidic optical element may be constant, i.e., across the areal dimensions of a lens. In further applications, the modulus of the gel may be configured such that the stiffness of the gel varies spatially. For example, an active fluidic optical element having a liquid-gel bilayer may be incorporated into a lens such that the gel layer has a lower modulus within a central region of the lens and an increasing modulus along radial directions and therefore a higher modulus within peripheral regions of the lens. Spatial control of the gel modulus may be achieved by controlling the crosslink density of the gel during fabrication (e.g., ink jet printing) of the gel layer.

In some examples, an active optical element may be incorporated into a display system, such as a head-mounted display for augmented reality or virtual reality devices. The presently-disclosed active fluidic optical elements may provide free space beam steering, form or constitute a transmission surface relief grating, or provide input/output coupling for a waveguide.

### Example Embodiments

Example 1: An optical element includes a bilayer having a fluid layer and a gel layer directly overlying the fluid layer, and a primary electrode disposed over a surface of the bilayer.

Example 2: The optical element of Example 1, where the fluid layer includes a liquid selected from a polyphenylether, polyphenyl thioether, 1,3-bis(phenylthio)benzene, silicone oil, and water.

Example 3: The optical element of any of Examples 1 and 2, where the fluid layer includes a gas selected from Ar, N₂, Kr, Xe, O₂, SF₆, CHF₃, CF₄, C₂F₆, C₃F₈, and air.

Example 4: The optical element of any of Examples 1-3, where the gel layer includes a compound selected from silicones and collagens.

Example 5: The optical element of any of Examples 1-4, where the gel layer has an elastic modulus of from approximately 1×10² Pa to approximately 5×10⁴ Pa.

Example 6: The optical element of any of Examples 1-5, where the fluid layer and the gel layer are substantially immiscible.

Example 7: The optical element of any of Examples 1-6, where a refractive index difference between the fluid layer and the gel layer is at least approximately 0.1.

Example 8: The optical element of any of Examples 1-7, where a density difference between the fluid and the gel is at least approximately 0.1 g/cm³.

Example 9: The optical element of any of Examples 1-8, where a thickness of the fluid layer and a thickness of the gel layer independently range from approximately 0.1 micrometer to approximately 10 micrometers.

Example 10: The optical element of any of Examples 1-9, where the primary electrode is optically transparent.

Example 11: The optical element of any of Examples 1-10, wherein a thickness of the primary electrode ranges from approximately 10 nm to approximately 50 nm.

Example 12: The optical element of any of Examples 1-11, where the primary electrode is configured as an array of discrete electrode segments.

Example 13: The optical element of Example 12, where two or more of the electrode segments are independently connected to a respective voltage source.

Example 14: The optical element of any of Examples 12 and 13, where floating electrode segments have areal dimensions less than areal dimensions of electrode segments connected to a voltage source.

Example 15: The optical element of any of Examples 1-14, further including a secondary electrode disposed over a surface of the bilayer opposite to the primary electrode.

Example 16: The optical element of Example 15, where the secondary electrode is configured as an array of discrete electrode segments.

Example 17: The optical element of any of Examples 1-16, where the bilayer is disposed between transparent substrates.

Example 18: An optical element includes a primary electrode, a secondary electrode overlapping at least a portion of the primary electrode, and a bilayer including a fluid layer and a gel layer disposed between and abutting the primary electrode and the secondary electrode.

Example 19: The optical element of Example 18, where the gel layer has an elastic modulus of from approximately 1×10² Pa to approximately 5×10⁴ Pa.

Example 20: A method includes forming a bilayer between a primary electrode and a secondary electrode, the bilayer including a fluid layer and a gel layer defining a boundary therebetween having a first shape, and applying a voltage across the bilayer in an amount effective to change the first shape of the boundary to a second shape and modify an optical response of the bilayer.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 3000 in FIG. 30) or that visually immerses a user in an artificial reality (such as, e.g., virtual-reality system 3100 in FIG. 31). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 30, augmented-reality system 3000 may include an eyewear device 3002 with a frame 3010 configured to hold a left display device 3015(A) and a right display device 3015(B) in front of a user's eyes. Display devices 3015(A) and 3015(B) may act together or independently to present an image or series of images to a user. While augmented-reality system 3000 includes two displays, embodiments of this disclosure may be implemented in augmented-reality systems with a single NED or more than two NEDs.

In some embodiments, augmented-reality system 3000 may include one or more sensors, such as sensor 3040. Sensor 3040 may generate measurement signals in response to motion of augmented-reality system 3000 and may be located on substantially any portion of frame 3010. Sensor 3040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 3000 may or may not include sensor 3040 or may include more than one sensor. In embodiments in which sensor 3040 includes an IMU, the IMU may generate calibration data based on measurement signals from sensor 3040. Examples of sensor 3040 may include, without limitation, accelerometers, gyroscopes, magnetometers, other suitable types of sensors that detect motion, sensors used for error correction of the IMU, or some combination thereof.

In some examples, augmented-reality system 3000 may also include a microphone array with a plurality of acoustic transducers 3020(A)-3020(J), referred to collectively as acoustic transducers 3020. Acoustic transducers 3020 may represent transducers that detect air pressure variations induced by sound waves. Each acoustic transducer 3020 may be configured to detect sound and convert the detected sound into an electronic format (e.g., an analog or digital format). The microphone array in FIG. 30 may include, for example, ten acoustic transducers: 3020(A) and 3020(B), which may be designed to be placed inside a corresponding ear of the user, acoustic transducers 3020(C), 3020(D), 3020(E), 3020(F), 3020(G), and 3020(H), which may be positioned at various locations on frame 3010, and/or acoustic transducers 3020(1) and 3020(J), which may be positioned on a corresponding neckband 3005.

In some embodiments, one or more of acoustic transducers 3020(A)-(J) may be used as output transducers (e.g., speakers). For example, acoustic transducers 3020(A) and/or 3020(B) may be earbuds or any other suitable type of headphone or speaker.

The configuration of acoustic transducers 3020 of the microphone array may vary. While augmented-reality system 3000 is shown in FIG. 30 as having ten acoustic transducers 3020, the number of acoustic transducers 3020 may be greater or less than ten. In some embodiments, using higher numbers of acoustic transducers 3020 may increase the amount of audio information collected and/or the sensitivity and accuracy of the audio information. In contrast, using a lower number of acoustic transducers 3020 may decrease the computing power required by an associated controller 3050 to process the collected audio information. In addition, the position of each acoustic transducer 3020 of the microphone array may vary. For example, the position of an acoustic transducer 3020 may include a defined position on the user, a defined coordinate on frame 3010, an orientation associated with each acoustic transducer 3020, or some combination thereof.

Acoustic transducers 3020(A) and 3020(B) may be positioned on different parts of the user's ear, such as behind the pinna, behind the tragus, and/or within the auricle or fossa. Or, there may be additional acoustic transducers 3020 on or surrounding the ear in addition to acoustic transducers 3020 inside the ear canal. Having an acoustic transducer 3020 positioned next to an ear canal of a user may enable the microphone array to collect information on how sounds arrive at the ear canal. By positioning at least two of acoustic transducers 3020 on either side of a user's head (e.g., as binaural microphones), augmented-reality device 3000 may simulate binaural hearing and capture a 3D stereo sound field around about a user's head. In some embodiments, acoustic transducers 3020(A) and 3020(B) may be connected to augmented-reality system 3000 via a wired connection 3030, and in other embodiments acoustic transducers 3020(A) and 3020(B) may be connected to augmented-reality system 3000 via a wireless connection (e.g., a BLUETOOTH connection). In still other embodiments, acoustic transducers 3020(A) and 3020(B) may not be used at all in conjunction with augmented-reality system 3000.

Acoustic transducers 3020 on frame 3010 may be positioned in a variety of different ways, including along the length of the temples, across the bridge, above or below display devices 3015(A) and 3015(B), or some combination thereof. Acoustic transducers 3020 may also be oriented such that the microphone array is able to detect sounds in a wide range of directions surrounding the user wearing the augmented-reality system 3000. In some embodiments, an optimization process may be performed during manufacturing of augmented-reality system 3000 to determine relative positioning of each acoustic transducer 3020 in the microphone array.

In some examples, augmented-reality system 3000 may include or be connected to an external device (e.g., a paired device), such as neckband 3005. Neckband 3005 generally represents any type or form of paired device. Thus, the following discussion of neckband 3005 may also apply to various other paired devices, such as charging cases, smart watches, smart phones, wrist bands, other wearable devices, hand-held controllers, tablet computers, laptop computers, other external compute devices, etc.

As shown, neckband 3005 may be coupled to eyewear device 3002 via one or more connectors. The connectors may be wired or wireless and may include electrical and/or non-electrical (e.g., structural) components. In some cases, eyewear device 3002 and neckband 3005 may operate independently without any wired or wireless connection between them. While FIG. 30 illustrates the components of eyewear device 3002 and neckband 3005 in example locations on eyewear device 3002 and neckband 3005, the components may be located elsewhere and/or distributed differently on eyewear device 3002 and/or neckband 3005. In some embodiments, the components of eyewear device 3002 and neckband 3005 may be located on one or more additional peripheral devices paired with eyewear device 3002, neckband 3005, or some combination thereof.

Pairing external devices, such as neckband 3005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 3000 may be provided by a paired device or shared between a paired device and an eyewear device, thus reducing the weight, heat profile, and form factor of the eyewear device overall while still retaining desired functionality. For example, neckband 3005 may allow components that would otherwise be included on an eyewear device to be included in neckband 3005 since users may tolerate a heavier weight load on their shoulders than they would tolerate on their heads. Neckband 3005 may also have a larger surface area over which to diffuse and disperse heat to the ambient environment. Thus, neckband 3005 may allow for greater battery and computation capacity than might otherwise have been possible on a stand-alone eyewear device. Since weight carried in neckband 3005 may be less invasive to a user than weight carried in eyewear device 3002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 3005 may be communicatively coupled with eyewear device 3002 and/or to other devices. These other devices may provide certain functions (e.g., tracking, localizing, depth mapping, processing, storage, etc.) to augmented-reality system 3000. In the embodiment of FIG. 30, neckband 3005 may include two acoustic transducers (e.g., 3020(l) and 3020(J)) that are part of the microphone array (or potentially form their own microphone subarray). Neckband 3005 may also include a controller 3025 and a power source 3035.

Acoustic transducers 3020(1) and 3020(J) of neckband 3005 may be configured to detect sound and convert the detected sound into an electronic format (analog or digital). In the embodiment of FIG. 30, acoustic transducers 3020(l) and 3020(J) may be positioned on neckband 3005, thereby increasing the distance between the neckband acoustic transducers 3020(l) and 3020(J) and other acoustic transducers 3020 positioned on eyewear device 3002. In some cases, increasing the distance between acoustic transducers 3020 of the microphone array may improve the accuracy of beamforming performed via the microphone array. For example, if a sound is detected by acoustic transducers 3020(C) and 3020(D) and the distance between acoustic transducers 3020(C) and 3020(D) is greater than, e.g., the distance between acoustic transducers 3020(D) and 3020(E), the determined source location of the detected sound may be more accurate than if the sound had been detected by acoustic transducers 3020(D) and 3020(E).

Controller 3025 of neckband 3005 may process information generated by the sensors on neckband 3005 and/or augmented-reality system 3000. For example, controller 3025 may process information from the microphone array that describes sounds detected by the microphone array. For each detected sound, controller 3025 may perform a direction-of-arrival (DOA) estimation to estimate a direction from which the detected sound arrived at the microphone array. As the microphone array detects sounds, controller 3025 may populate an audio data set with the information. In embodiments in which augmented-reality system 3000 includes an inertial measurement unit, controller 3025 may compute all inertial and spatial calculations from the IMU located on eyewear device 3002. A connector may convey information between augmented-reality system 3000 and neckband 3005 and between augmented-reality system 3000 and controller 3025. The information may be in the form of optical data, electrical data, wireless data, or any other transmittable data form. Moving the processing of information generated by augmented-reality system 3000 to neckband 3005 may reduce weight and heat in eyewear device 3002, making it more comfortable to the user.

Power source 3035 in neckband 3005 may provide power to eyewear device 3002 and/or to neckband 3005. Power source 3035 may include, without limitation, lithium ion batteries, lithium-polymer batteries, primary lithium batteries, alkaline batteries, or any other form of power storage. In some cases, power source 3035 may be a wired power source. Including power source 3035 on neckband 3005 instead of on eyewear device 3002 may help better distribute the weight and heat generated by power source 3035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 3100 in FIG. 31, that mostly or completely covers a user's field of view. Virtual-reality system 3100 may include a front rigid body 3102 and a band 3104 shaped to fit around a user's head. Virtual-reality system 3100 may also include output audio transducers 3106(A) and 3106(B). Furthermore, while not shown in FIG. 31, front rigid body 3102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 3000 and/or virtual-reality system 3100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 3000 and/or virtual-reality system 3100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 3000 and/or virtual-reality system 3100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a fluid layer that comprises or includes 1,3-bis(phenylthio)benzene include embodiments where a fluid layer consists essentially of 1,3-bis(phenylthio)benzene and embodiments where a fluid layer consists of 1,3-bis(phenylthio)benzene.

What is claimed is:

1. An optical element comprising:
a bilayer including a fluid layer and a gel layer directly overlying the fluid layer; and
a primary electrode disposed over a surface of the bilayer.

2. The optical element of claim 1, wherein the fluid layer comprises a liquid selected from the group consisting of a polyphenylether, polyphenyl thioether, 1,3-bis(phenylthio)benzene, silicone oil, and water.

3. The optical element of claim 1, wherein the fluid layer comprises a gas selected from the group consisting of Ar, N₂, Kr, Xe, O₂, SF₆, CHF₃, CF₄, C₂F₆, C₃F₈, and air.

4. The element of claim 1, wherein the gel layer comprises a compound selected from the group consisting of silicones and collagens.

5. The element of claim 1, wherein the gel layer has an elastic modulus of from approximately 1×10² Pa to approximately 5×10⁴ Pa.

6. The optical element of claim 1, wherein the fluid layer and the gel layer are substantially immiscible.

7. The optical element of claim 1, wherein a refractive index difference between the fluid layer and the gel layer is at least approximately 0.1.

8. The optical element of claim 1, wherein a density difference between the fluid and the gel is at least approximately 0.1 g/cm³.

9. The optical element of claim 1, wherein a thickness of the fluid layer and a thickness of the gel layer independently range from approximately 0.1 micrometer to approximately 10 micrometers.

10. The optical element of claim 1, wherein the primary electrode is optically transparent.

11. The optical element of claim 1, wherein a thickness of the primary electrode ranges from approximately 10 nm to approximately 50 nm.

12. The optical element of claim 1, wherein the primary electrode is configured as an array of discrete electrode segments.

13. The optical element of claim 12, wherein two or more of the electrode segments are independently connected to a respective voltage source.

14. The optical element of claim 12, wherein floating electrode segments have areal dimensions less than areal dimensions of electrode segments connected to a voltage source.

15. The optical element of claim 1, further comprising a secondary electrode disposed over a surface of the bilayer opposite to the primary electrode.

16. The optical element of claim 15, wherein the secondary electrode is configured as an array of discrete electrode segments.

17. The optical element of claim 1, wherein the bilayer is disposed between transparent substrates.

18. An optical element comprising:
a primary electrode;
a secondary electrode overlapping at least a portion of the primary electrode; and
a bilayer including a fluid layer and a gel layer disposed between and abutting the primary electrode and the secondary electrode.

19. The optical element of claim 18, wherein the gel layer has an elastic modulus of from approximately 1×10² Pa to approximately 5×10⁴ Pa.

20. A method comprising:
forming a bilayer between a primary electrode and a secondary electrode, the bilayer including a fluid layer and a gel layer defining a boundary therebetween having a first shape; and
applying a voltage across the bilayer in an amount effective to change the first shape of the boundary to a second shape and modify an optical response of the bilayer.
